(19) United States
(12) Patent Application Publication
(10) Pub. No.: US 2009/0316687 A1
(43) Pub. Date: Dec. 24, 2009

(54) PEER TO PEER INBOUND CONTACT CENTER

(75) Inventor: Serge Kruppa, London (GB)

Correspondence Address: THE ECLIPSE GROUP LLP, 10605 BALBOA BLVD., SUITE 300, GRANADA HILLS, CA, 91344, US

(73) Assignee: Peerant, Inc., Campbell, CA (US)

(21) Appl. No.: 12/282,461

(22) PCT Filed: Mar. 12, 2007
(86) PCT No.: PCT/US07/63834

§ 371 Date: Jan. 26, 2009

Related U.S. Application Data
(60) Provisional application No. 60/781,472, filed on Mar. 10, 2006.
(60) Provisional application No. 60/799,117, filed on May 9, 2006.

(51) Int. Cl. H04L 12/66; G06F 15/16

(52) U.S. Cl. 370/352; 709/205

(57) ABSTRACT

A system and method for implementing a contact center on a device node connected to a data network. The system includes a peer-to-peer inbound contact center system that executes in each device node to enable peer-to-peer connections between users making interaction requests at a requesting device and a destination interaction endpoint. Device nodes may be VoIP telephones, computers having soft-phones, computers having a CTI-enabled PBX interface to implement CTI-enabled telephones as interaction endpoints.

### CROSS-REFERENCE TO RELATED APPLICATIONS

This application claims priority of U.S. Provisional Patent Application Ser. No. 60/799,117 filed on May 9, 2006, titled “Peer To Peer Inbound Contact Center Having Systems And Methods For Initiating Connections From A Client User Interface” and of U.S. Provisional Patent Application Ser. No. 60/781,472 filed on Mar. 10, 2006, titled “Peer-to-Peer Inbound Contact Center,” both of which are incorporated by reference in this application in their entirety.

### 1. FIELD OF THE INVENTION

This invention relates the field of contact centers, and in particular to, contact centers implemented to include connections over data networks.

### 2. RELATED ART

A typical contact center is a centralized office used for the purpose of receiving and transmitting a large volume of requests by telephone. Contact centers are typically operated by a company to administer incoming product support or information inquiries from consumers. Outgoing calls for telemarketing, clientele, and debt collection may also be made. Systems for collective handling of letters, faxes, and e-mails may also be known as contact centers.

Today's contact centers tend to be centralized, heavy-weight systems that require expensive, complex, servers to process interaction requests. As such, contact centers are difficult to implement in ad hoc deployments (e.g. in emergency situations) or in small customer deployments (e.g. individuals or small-medium sized enterprises (SME)). Such systems cannot be installed in less than several days of work without significant investment in professional services and material. They also imply a fork-lift upgrade of existing telecommunication and computing infrastructure to achieve a homogeneous single-vendor interaction processing environment. Even if these goals are reached, the resulting inbound contact center has serious scalability and reliability limitations (e.g. it cannot scale globally for instance and server failures tend to drastically impair its operation).

Today's contact centers are server-centric (or network-centric), fixed, controlled, and centralized, and are accordingly becoming less and less adapted to an increasingly heterogeneous, dynamic, distributed, converged world of telecommunications. Today's customers and potential customers may establish contact via a wide variety of channels and endpoints, such as, e.g. VoIP, via SIP or vendor specific protocols, video, chat, etc. Allowing for enough channels and providing resources for responding to customers and potential customers is becoming increasingly difficult for contact centers. One feature that such known contact centers may implement is a “click-to-call” feature. A “click-to-call” feature may be implemented by a contact center sponsor on a web-page to allow a user/client access to the sponsor's agents (e.g. sales, customer service or support) by simply selecting a button or other link on a web-page (for example). The “click-to-call” provides a user with quick and easy access to a sponsor's agents allowing the user to obtain live answers to questions, or other information that may influence a decision to do business with the sponsor. In the server-centric contact centers, “is most often implemented as an extension module of the contact center server with sometimes a thin client component running on the user's device.” The “click-to-call” feature is therefore dependent on the contact center infrastructure. Thus, the “click-to-call” feature has a limited reach and suffers from same limitations and lack of flexibility as its contact center infrastructure.

Therefore, there is a need for contact center methods and systems that overcome the disadvantages set forth above and others previously experienced.

### SUMMARY

In view of the above, systems and methods are provided for implementing a contact center. An example system includes a data network and a plurality of devices, each having a central processing unit, memory resources and a data network interface to the data network. The devices include an interaction endpoint to communicate in a peer-to-peer communications connection over the data network. A contact center function executes in each device. The contact center function includes a peer-to-peer resource manager to create and manage peer-to-peer communications connections between other devices and a requesting device used by a user to initiate an interaction request. The contact center function also includes an endpoint adapter operable to interface between the peer-to-peer contact center function and the interaction endpoint.

Various advantages, aspects and novel features of the present invention, as well as details of an illustrated embodiment thereof, will be more fully understood from the following description and drawings.

Other systems, methods and features of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE FIGURES

The components in the figures are not necessarily to scale, emphasis instead being placed upon illustrating the principles of the invention. In the figures, like reference numerals designate corresponding parts throughout the different views.

FIG. 1A is a schematic diagram illustrating an example of a system for implementing a contact center consistent with the present invention.

FIG. 1B-1D are diagrams illustrating operation of an example of the system in FIG. 1A.

FIG. 2 is an example implementation of the system of FIG. 1A.

FIG. 3 is another example implementation of the system of FIG. 1A.

FIG. 4 is an example of an implementation using personal computers configured to provide user communication with soft phones.

FIG. 5A is an example of an implementation of the system of FIG. 1A using voice-over-Internet Protocol (“VoIP”) telephones.

FIG. 5B is an example of an implementation of the system of FIG. 1A using a CTI-enabled PBX via an external PC.

FIG. 6A is a flowchart illustrating operation of an example of a method for initializing a contact center.

FIG. 6B is a flowchart illustrating operation of an example of a method for providing a user with a peer-to-peer connection to a destination endpoint in the contact center.

FIG. 7 is a schematic network diagram of an example of a P2P inbound contact center that implements an example of a system for initiating connections from a user interface consistent with the present invention.

FIG. 8 is a schematic network diagram of the system in FIG. 7 depicting example data structures that may be used by the contact center.

FIG. 9 is a schematic network diagram of the system in FIG. 7 depicting operation of the example system for initiating connections from the user interface.

FIG. 10 is a schematic network diagram of the system in FIG. 7 illustrating an example operation performed during initiation of the connection.

FIG. 11 is a schematic network diagram of the system in FIG. 7 illustrating additional operations performed during initiation of the connection.

FIG. 12 is a schematic network diagram of the system in FIG. 7 illustrating additional operations performed during initiation of the connection.

FIG. 13 is a schematic network diagram of the system in FIG. 7 illustrating operations performed during the termination of the connection.

FIG. 14 is an example display notifying a user that his/her call has been placed in a queue until an agent is available.

FIG. 15 is an example of a user interface for a campaign manager consistent with the examples of the present invention.

### DETAILED DESCRIPTION

In the following description of preferred embodiments, reference is made to the accompanying drawings that form a part hereof, and which show, by way of illustration, specific embodiments in which the invention may be practiced. Other embodiments may be utilized and structural changes may be made without departing from the scope of the present invention.

### I. Example Inbound Contact Center Systems

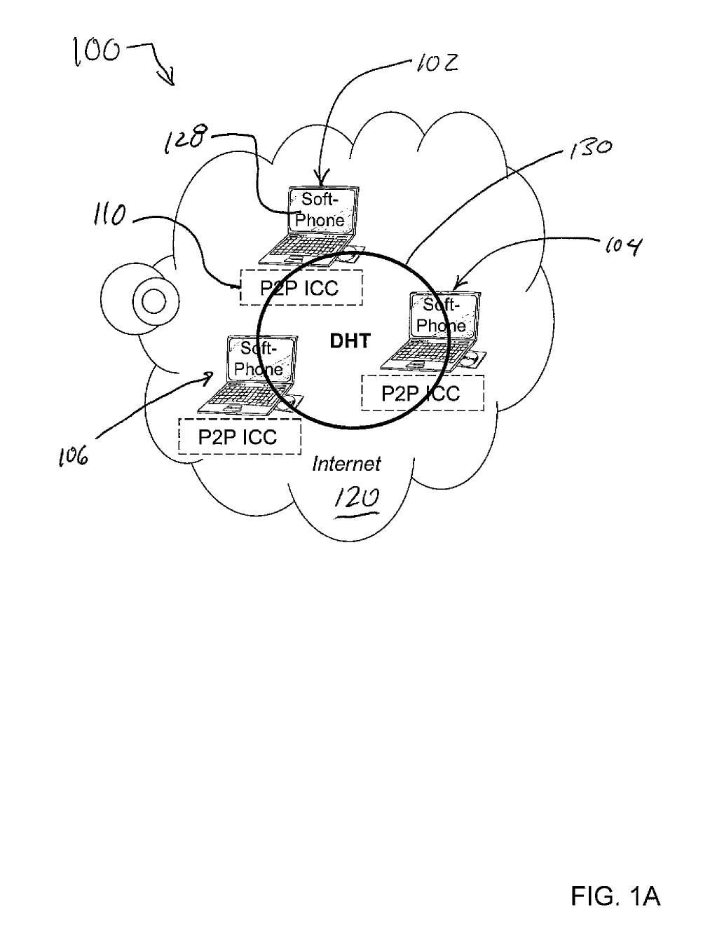

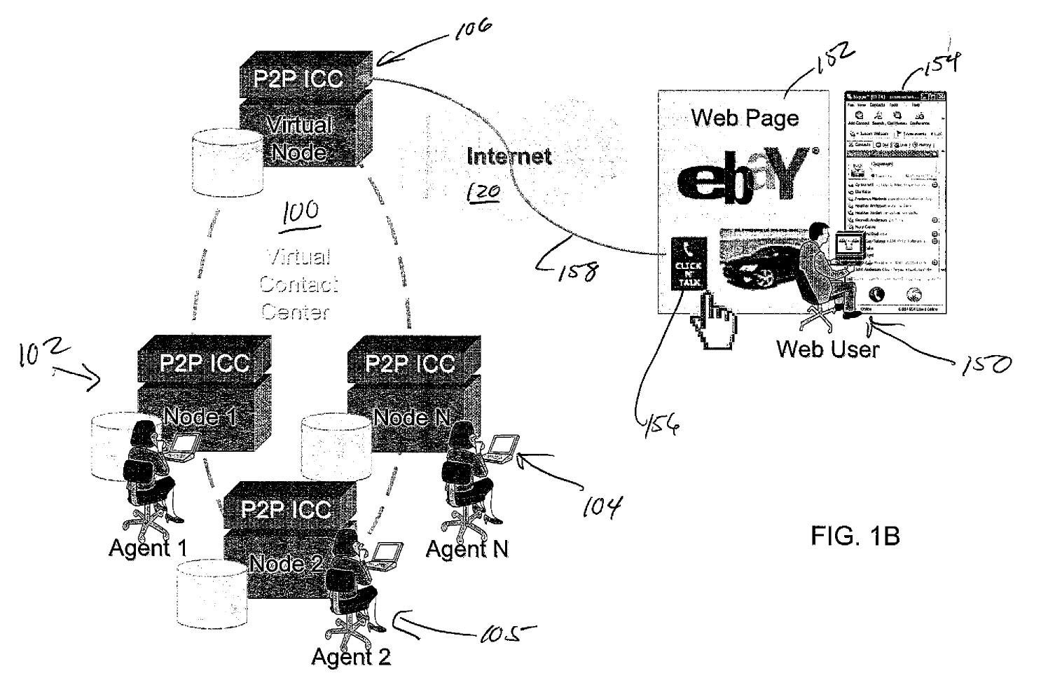

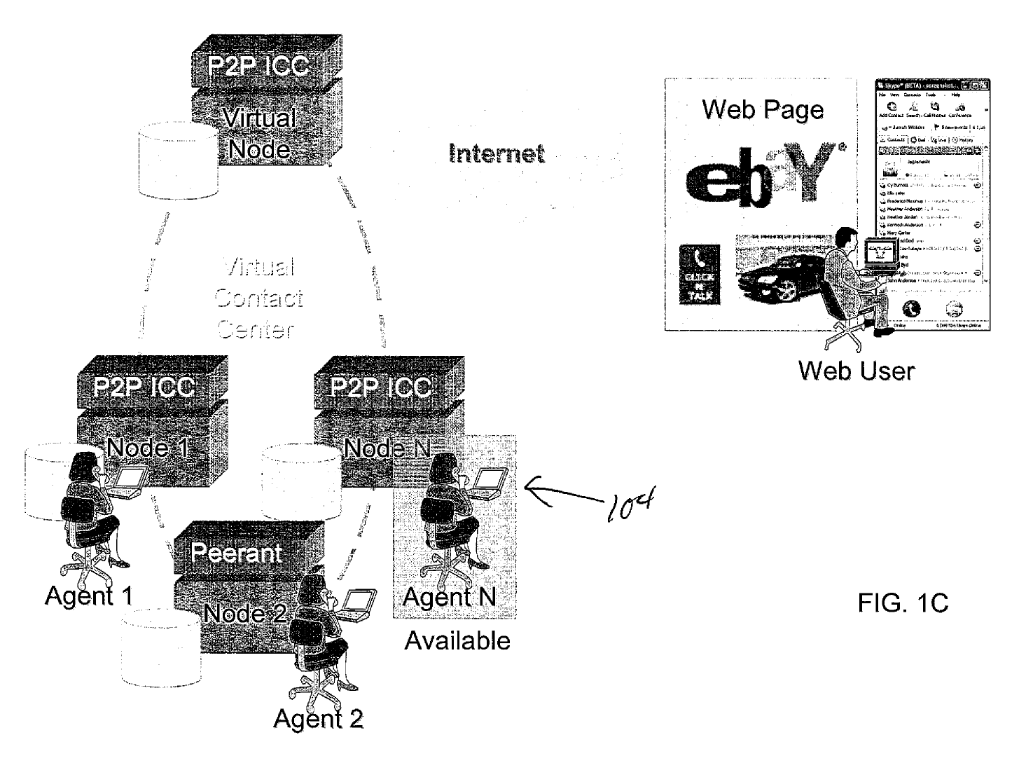

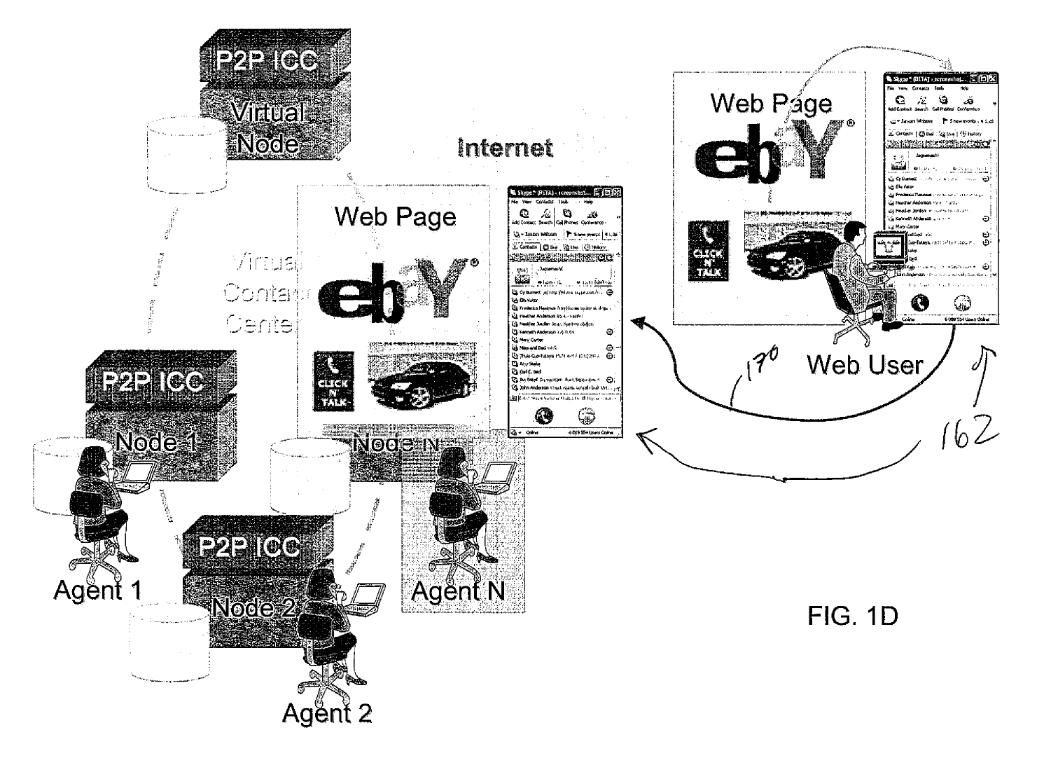

Systems and methods consistent with the present invention include a contact center method and system that may process multimedia interaction requests with improved scalability, reliability, setup time and cost. FIG. 1A is a schematic diagram illustrating an example of a system 100 for implementing a contact center consistent with the present invention. The system 100 in FIG. 1A includes a first networked device node 102, a second networked device node 104, and a third networked device node 106 connected to communicate over the Internet 120. Each networked device node 102, 104, 106 includes a peer-to-peer inbound contact center (P2P ICC) software component 110 executing on a computing device 128. Each networked device node 102, 104, 106 may implement interaction endpoints, which receive contact center interaction requests. In this context, an interaction request can be, for example, a PSTN telephone call, a VoIP call, an e-mail, a chat request, a Web collaboration request, an SMS, etc. The P2P ICC software component 110 includes resources to operate in a distributed hash table 130 that may include an overlay structure capable of processing peer-to-peer connectivity by converting and unifying existing interaction endpoints into a server-less contact center.

The networked device nodes 102, 104, 106 may be any computer or computers, or computer-controlled devices such as, for example, laptop computers, workstations, and VOIP-telephones as well as mobile phones, PDAs, tablet PCs and other mobile devices with wireless networking capabilities. Networked device nodes 102, 104, 106 may be connected to the Internet 120 in a manner that would make it physically accessible to users that would be sending interaction requests. Such users may communicate to the networked device nodes 102, 104, 106 using a computer (workstation, laptop, etc.), a VoIP telephone, or a plain old telephone system (POTS) telephone. The networked device nodes 102, 104, 106 may also connect to the Internet 120 and be accessible via a private branch exchange (PBX) enabled with Computerized Telephony Integration (CTI). Networked device nodes 102, 104, 106 may be any devices through which an interaction endpoint may be established, or through which a resource of the contact center may be provided (e.g. an integrated voice response [IVR]). A networked device node 102, 104, 106 may also be a server that provide storage or transaction processing facilities for contact center data. Networked device nodes 102, 104, 106 include a relation or connection to an interaction endpoint that participates in the contact center system.

The P2P ICC software component 110 includes core logic for handling inbound interaction requests. A system component called an ACD (Automatic Call Distributor) may be included to process most of the interaction requests. The ACD may perform functions such as interaction requests queuing (for example, placing interaction requests in a universal queue), intelligent interaction requests distribution amongst agent groups, skills based interaction requests routing (e.g. route calls from English speaking customers to English speaking agents), etc. The ACD works in conjunction with other contact center system components like the IVR (Interactive Voice Response) to efficiently process an interaction request. The P2P ICC software component 110 includes program logic to handle incoming interaction requests in a peer to peer context. The P2P ICC software component 110 interfaces with a distributed network data structure, such as the DHT 130, to perform decision-making based on relevant information about the state of the P2P ICC software component 110. Supplementary services that may be supported by the P2P ICC software component 110 include: authentication, interface to a route location service, etc.

FIGS. 1B-1D illustrate an example of operation of the system in FIG. 1A. In FIG. 1B, a web user 150 (a user of the World-Wide Web) may be operating a personal computer with a browser open to a web page 152 (e.g. the eBay™ web-site). The web user 150 may also be using a soft-phone 154 (e.g. a Skype™ phone) on the computer. The web page 152 may include an advertisement with a click-to-call button 156 and the user 150, having an interest in the subject matter of the advertisement, may select the click-to-call button 156. The click-to-call button 156 may be configured to trigger the soft-phone 154 to initiate a telephone call 158 over the Internet 120 to the networked device node 106 in the contact center system 100. The P2P ICC software component 110 operating in the networked device node 106 may process the call and recognize it as an interaction request, and note that no agents are available to handle the interaction request. The P2P ICC software component 110 may then place the interaction request in a unified queue (that is, a queue for the distributed contact center system) until one of the agents at one of the networked device nodes 102, 104, 105, 106 becomes available.

At FIG. 1C, the agent at device node 104 becomes available and searches for interaction requests in the queue. The P2P ICC 110 software component operating in the device node 104 may perform a specialized search. For example, the search may be for an interaction request that would be handled by a certain set of characteristics; such as for example, skills based routing, idle time, call distribution, geography, and other characteristics that may be accounted for by a typical ACD. In FIG. 1D, the agent at the device node 104 addresses the interaction request made by the web user 150. In the example shown in FIG. 1D, the desktop 162 on the computer being used by the web user 130 may be made accessible to the agent at the device node 104. A soft-phone telephone connection 170 may be created between the web user 130 and the agent. Other relevant data may be accessed by the agent to establish a context in which the agent may best assist the web user 130 with the web user's 130 search for information.

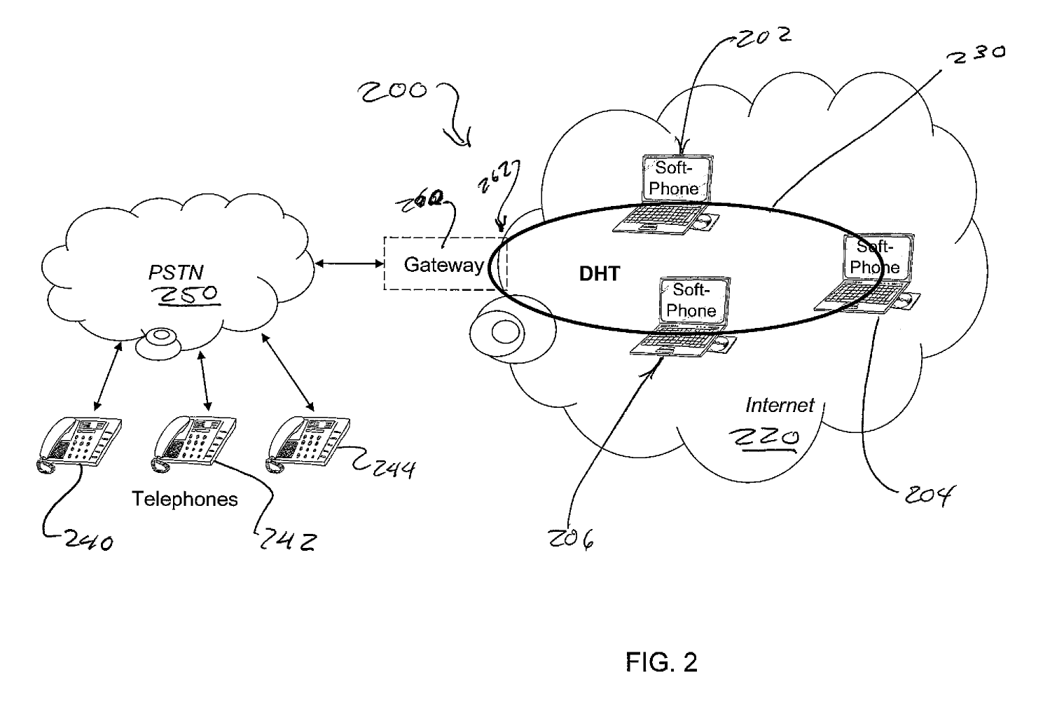

The system 100 in FIG. 1A may be configured to implement a full-function contact center in a variety of ways. FIG. 2 shows an example of a system for implementing a contact center 200 having a first networked device node 202, a second networked device node 204 and a third networked device node 206 connected to the Internet 220. Each networked device node 202, 204, 206 is a notebook computer that includes soft-phone programs interaction endpoint as well as the P2P ICC software component. The notebook computers 202, 204, 206 are networked together into a logical data storage and retrieval construct—a DHT 230.

Users may access the contact center 200 to make interaction requests using POTS telephones 240, 242, 244 connected to the Public Switched Telephone Network (“PSTN”) 250. A gateway 260 may be connected to the PSTN 250 and configured to permit calls made by users at the POTS telephones 240, 242, 244 to reach one of the networked device nodes 202, 204, 206. In the example shown in FIG. 2, the DHT 230 may include a P2P ICC software accessory (e.g. a plugin) 266 to allow the gateway 260 access to the DHT 230 in an intelligent manner.

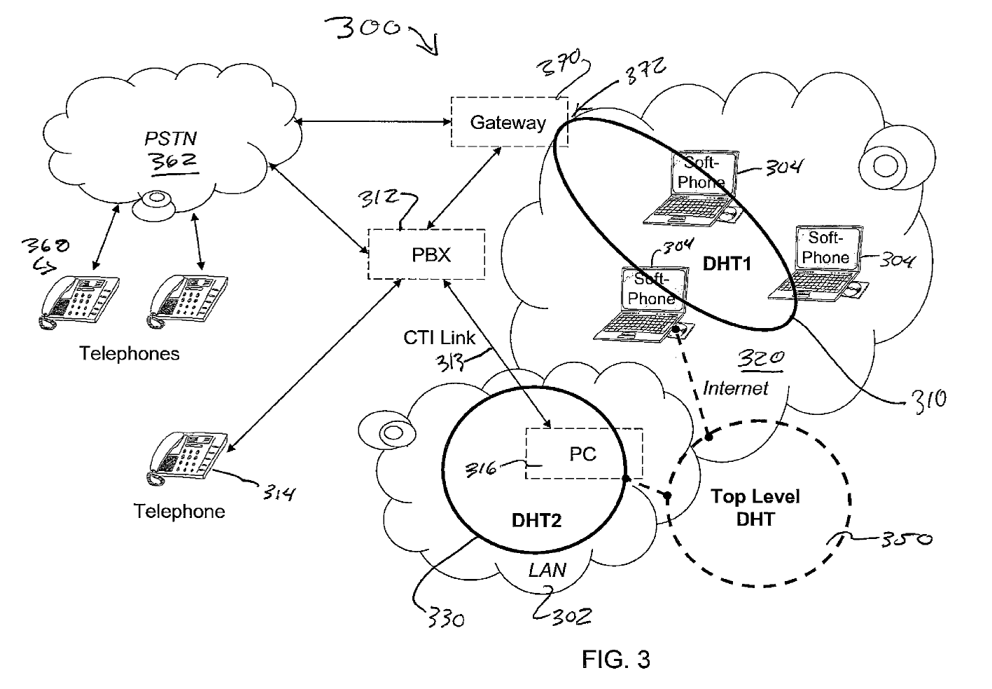

FIG. 3 is another example of a system for implementing a contact center 300 that provides connectivity for interaction requests via an enterprise LAN 302 and the Internet 320. A plurality of notebook computers 304 are networked together via a first DHT 310 over the Internet 320. A PBX 312 may be connected to the enterprise LAN 302 to permit the use of a POTS telephone 314 to process interaction requests. The PBX 312 may connect to a computer 316 via a CTI link 313 on the enterprise LAN 302 to obtain connectivity via a second DHT 330. A top-level DHT 350 may be further implemented to process requests for connectivity between the first and second DHTs 310, 330. Alternatively, a single DHT with specific properties of key space partitioning can be used instead of hierarchical DHTs.

The system 300 in FIG. 3 may receive interaction requests from users on either POTS telephones 360 connected to the PSTN 362 or from other networked entities (not shown) that may be connected to the Internet 320. The POTS telephones 360 may send interaction requests to either the plurality of notebooks 304 via a gateway 370, or to agents on the POTS telephone 314 via the PBX 312. The DHT 310 may include a P2P ICC software accessory 372 to allow the gateway 370 access to the DHT 310.

The systems shown in FIGS. 1-3 establish contact center connections as peer-to-peer connections. However, some endpoints that are handled by the P2P ICC software component may be inherently server-based connections; such as for example, VoIP connections using SIP and chat room connections. Such connections may be handled as interaction requests by the P2P ICC software component, and then routed as peer-to-peer connections to an appropriate endpoint in the contact center system regardless of the server-based nature of the interaction request connection.

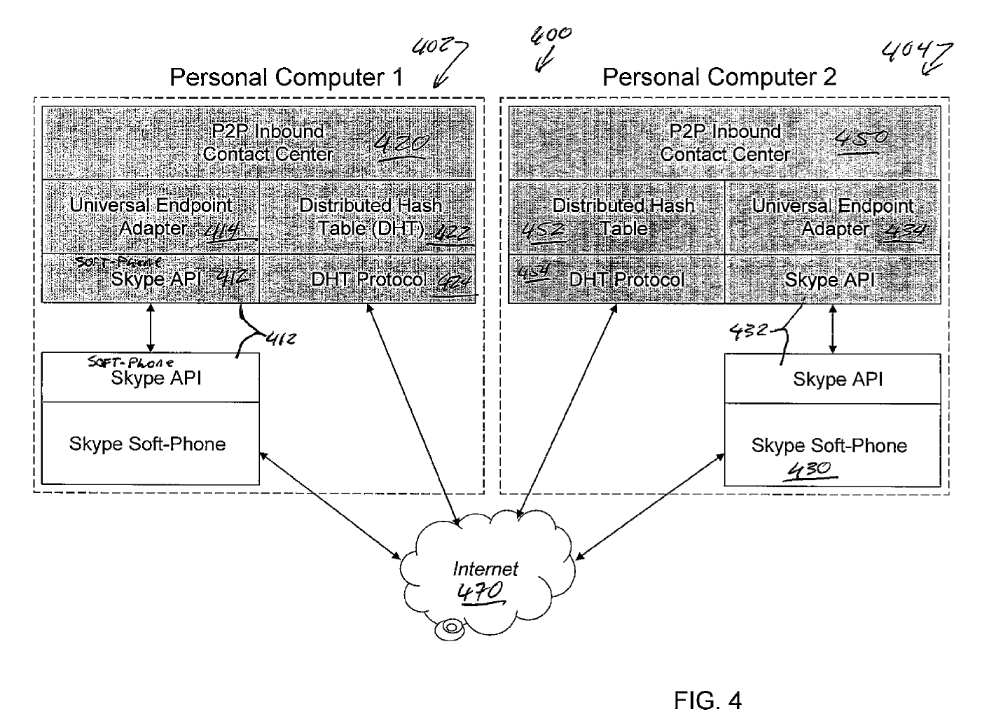

FIGS. 1-3 illustrate just a few examples of how nodes may be connected via a DHT to implement contact centers. The P2P ICC function may be implemented in software that may operate on any computer (i.e. workstation, notebook, handheld, etc.), VoIP telephone or mobile telephone. The P2P ICC function may also be implemented in a PBX, either internally or via a CTI link connected computer to enable a POTS telephone to accept interaction requests as an endpoint in the contact center. Examples of implementation of P2P ICC functions in various nodes are illustrated and described below with reference to FIGS. 4-6.

### II. Example Networked Device Nodes

FIG. 4 is an example of a contact center system 400 in which a first personal computer 402 and a second personal computer 404 may receive interaction requests over the Internet 410. In general, a node that implements an endpoint to access the contact center may include various features such as a universal endpoint interface, an endpoint capabilities and status discovery mechanism, an endpoint naming service and target endpoint resolution, interaction routing, interaction queuing, intelligent interaction distribution to endpoints, all implemented according to peer-to-peer (P2P) principles requiring nothing more than edge devices with support for control and monitoring from a third party entity.

In the system 400 in FIG. 4, the first personal computer 402 includes a first PC soft-phone 410, a corresponding PC soft-phone program interface (API) 412 and the contact center software. The second personal computer 404 includes a second PC soft-phone 430, a corresponding PC soft-phone API 432, and the contact software. The first PC 402 and the second PC 404 are connected to communicate over the Internet 470.

The contact center software in the first and second PCs 402, 404 is shown as modules that may be, either statically linked into one program, or distributed between different programs communicating via a protocol like TCP/IP. Because of the distributed nature of the operation of the contact center software modules, the description below makes reference to the network structures described above with reference to FIGS. 1-3.

In the first PC 402, these modules are:
(1) a Universal Endpoint Adapter 414;
(2) a Distributed Hash Table (DHT) 422;
(3) a Distributed Hash Table Protocol 424; and
(4) a Peer to Peer Inbound Contact Center (P2P ICC) 420.
   The second PC 404 in FIG. 4 has the same contact center software modules (i.e. a Universal Endpoint Adapter 434, a DHT 452, a DHT Protocol 454; and a P2P ICC 420). The soft-phones 410, 430 provide access to reception of interaction requests from users of the contact center.

The Universal Endpoint Adapter module 414, 434 performs the role of integration layer between the contact center core logic (i.e. the service script executed in the P2P ICC 420)″ and an interaction endpoint, which may receive the actual contact center interaction requests. The Universal Endpoint Adapter module 414, 434 may include functions similar to a traditional CTI (Computer Telephony Integration) implementation, though an interaction endpoint may be e-mail or a chat program as well as a telephone. The Universal Endpoint Adapter module 414, 434 allows the contact center core logic to monitor and control the behavior of the interaction endpoint to which it is connected. In the example shown in FIG. 4, the interaction endpoint is the soft-phone 410, 430, via the soft-phone API 412, 432. The Universal Endpoint Adapter module 414, 434 may support APIs and protocols from various interaction endpoints and may provide an abstract control and monitoring API to the contact center core logic.

The DHT 422, 452 performs functions such as storing data in hash tables in geographically distributed locations in order to provide a failsafe lookup mechanism for distributed computing. The DHT 422, 452 provides a fault tolerant storage interface on top of which is layered the contact center core application logic. In diagrams of network structures such as those in FIGS. 1-3, the DHT 422, 452 is often represented as a circular data structure where key-value pairs are stored amongst N networked device nodes. The contact center uses its own DHT as a logical data storage space. Upon joining the contact center, every interaction endpoint may store within its DHT 422, 452, some essential information, such as, for example: an agent name, a set of agent skills, agent status, agent idle time, endpoint capabilities, etc. Whenever an event occurs at an endpoint that causes a value to become invalid, that value is updated in the DHT 422, 452. The DHT 422, 452 is the main repository of contact center data across all network nodes. Any contact center interaction endpoint may be capable of performing a lookup of the DHT 422, 452 to find the value associated with a specific key. In substance, the knowledge about the state of a specific interaction endpoint may be spread between all the contact center device nodes (see, for example, FIG. 3), as opposed to the conventional centralized contact center model.

In the example system 400 in FIG. 4 and in other example systems for implementing a contact center, issues of security and privacy are addressed using the DHT 422, 452 in the contact center. The DHT 422, 452 is a hierarchical or partitioned construct that ensures that a key is stored in the inserter's own contact center DHT ring, which conforms with a property known as content locality. The DHT 422, 452 also ensures that a routing path stays entirely within a contact center DHT ring when possible, which conforms with a property known as path locality.

As shown in the network structure in FIG. 3, a contact center may include multiple (e.g. two) contact center DHT rings structured into a multi-ring hierarchy (the top-level ring 350 in FIG. 3 being used to route inter-ring queries and to enable contact center-wide lookup of keys, while contact center private keys are stored in the lower level rings 310, 330). DHT Gateways are used by lower level rings to securely communicate with higher level rings across domain and network boundaries (e.g. different contact centers or NAT/firewalls). Each DHT is its own private and secure administrative domain. Additionally, values contained in key-value pairs may be encrypted to provide added security.

A multi-ring protocol may connect the DHT rings together, supporting global routing and lookup amongst all interaction endpoints participating in a DHT hierarchy. This allows the contact center to span multiple contact centers and networks. Each ring can use, in addition to DHT's, any protocol that supports a key based routing (KBR) API (although other abstract APIs may also be employed). DHT rings may be joined by nodes from different rings. Alternatively, gateway nodes may be used to join the rings. Such ring gateways may use a “group any” cast mechanism such as SCRIBE to publicize their existence to other nodes in the rings to which they belong. Ring gateways may do so by subscribing to an “any cast” group in each of the rings. Queries from other contact center rings may be received through the ring gateways via the SCRIBE multicast trees.

The DHT Protocol module 424, 454 allows contact center devices to communicate with each other and enables essential DHT operations such as put, get, remove, join, leave, lookup, etc. In one example contact center system, the DHT Protocol module 424, 454 may use the Session Initiation Protocol (SIP), which is used in many commercial VoIP telephones, and offers facilities to establish communications through firewalls and NATs. However, the DHT Protocol module 424, 454 is not limited to using SIP and other protocols may be used, particularly if such protocols. For example, An effective DHT protocol implementation would support any network topology with NATs and firewall devices. Using HTTP tunneling to a “rendez-vous” server combined with UDP hole punching capabilities allow each peer or device node in the P2P ICC to communicate with any other peer or device node. For added security, the DHT payload of a message may be encrypted.

The P2P ICC module 420, 450 includes core program logic for handling inbound interaction requests. In typical inbound contact centers, most of the interaction requests processing decisions are made by a system component called an ACD (Automatic Call Distributor). The ACD implements functions to perform interaction requests queuing (for example, placing them in a universal queue), intelligent interaction requests distribution amongst agent groups, skills based interaction requests routing (e.g. route calls from English speaking customers to English speaking agents), etc. The ACD works in conjunction with other contact center system components like the IVR (Interactive Voice Response) to efficiently process an interaction request. The P2P ICC module 420, 450 includes program logic for handling incoming interaction requests in a peer to peer context. The P2P ICC module 420, 450 interfaces with the Universal Endpoint Adapter 414, 434 for real time control and monitoring of the interaction endpoint and with the DHT 432, 452 for taking the most appropriate decision based on all the relevant information about the state of the P2P inbound contact center. Supplementary services supported by the P2P ICC module 420, 450 may include: authentication, interface to a route location service, etc. The P2P ICC module is not limited to providing a contact center service: it is effectively a peer-to-peer runtime environment allowing the execution of a variety of telephony and transactional applications, specified for instance using a high level domain specific scripting language

The soft-phones 410, 430 in both of the personal computers 402, 404 are the commercially-available Skype™ soft-phones. However, any suitable alternative may be used, including SIP soft-phones with a built-in API or any media processing platform with CTI or similar monitor and control capabilities. The Skype™ soft-phones 410, 430 communicate with applications via a Skype™ API s 412, 432. The Skype™ soft-phones 410, 430 and other PC components that may be used by the contact center software include an interface to a data network connection to other devices running the contact center software. This could be an Ethernet LAN linking together various PCs 402, 404, or a Wide Area Network (WAN) connection such as an ADSL link to the Internet (described below with reference to FIG. 4). The physical nature of the network (e.g. wireless or wireline) is irrelevant for the correct operation of the contact center. Likewise, any transport protocol can be used, although the preferred embodiment uses TCP/IP.

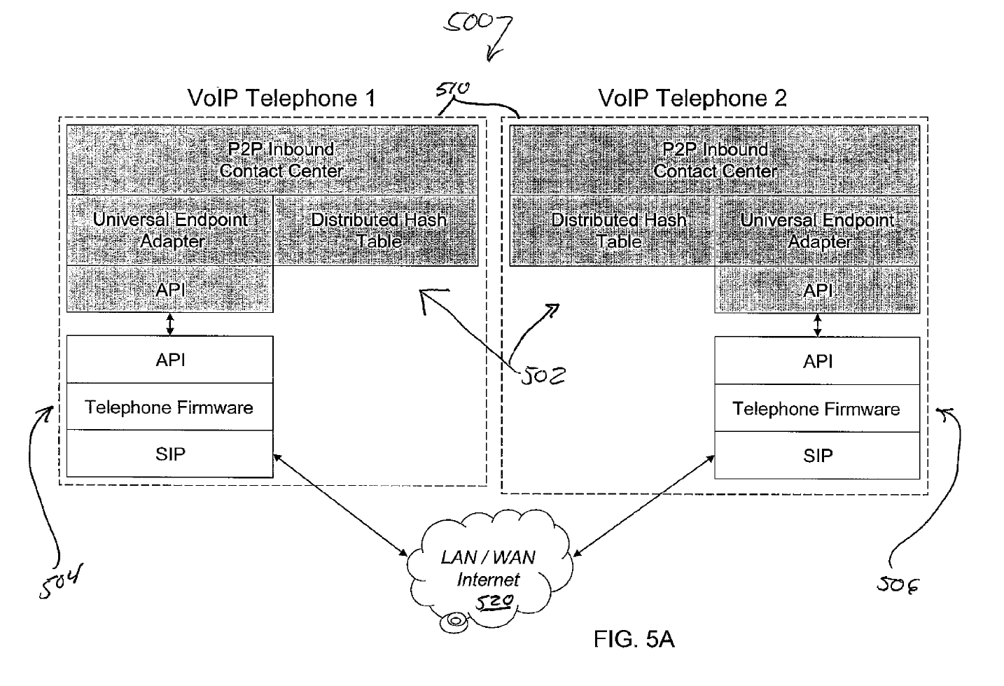

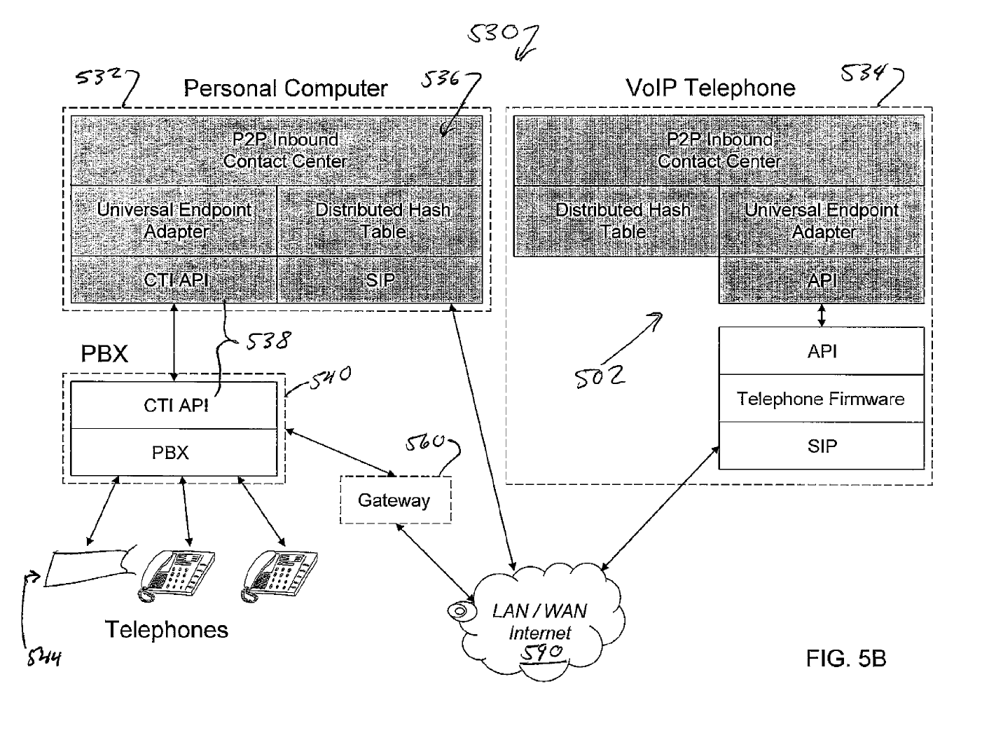

The example system 400 for implementing the contact center in FIG. 4 may be software programs executing on a central processing unit (CPU) and memory (RAM) system of a computer or telecommunications device such as a PC, server, VoIP telephone, mobile phone, etc. FIGS. 5A and 5B depict examples of alternative devices in which example contact center software may be implemented.

FIG. 5A is a block-diagram illustrating an example of the P2P Inbound Contact Center software modules 502 integrated in first and second VoIP telephone sets 510. The VoIP telephone sets 510 include telephone functions 504 and a data network interface to enable telephony functions over a data network 520, such as the Internet, or a Wide-Area Network (WAN). In the system 500 shown in FIG. 5A, the VoIP telephones 510 include a SIP layer 512, which provides a network interface for the P2P ICC software 502 including the DHT protocol.

FIG. 5B is a block diagram depicting another example of a system 530 for implementing the P2P ICC software modules. The system 530 in FIG. 5B includes a personal computer 532 and a VoIP telephone 534. The VoIP telephone 534 may execute the P2P ICC software modules 502 described with reference to FIG. 5A. The personal computer 532 may include a similar P2P ICC module 536 including a CTI API 538 to enable communication with a CTI-enabled PBX 540. The CTI-enabled PBX 540 includes connections to a plurality of local telephones 544. The personal computer 532 includes a DHT protocol that interfaces to a data network 590. The CTI-enabled PBX 540 communicates with the data network 590 via a gateway 560. The personal computer 532 allows the P2P ICC software modules 536 to communicate via a DHT ring hierarchy with the P2P ICC software modules 502 and to enable the local telephones 544 to operate as endpoints for interaction requests.

### III. Description of Operation of Example Systems for Implementing a Contact Center

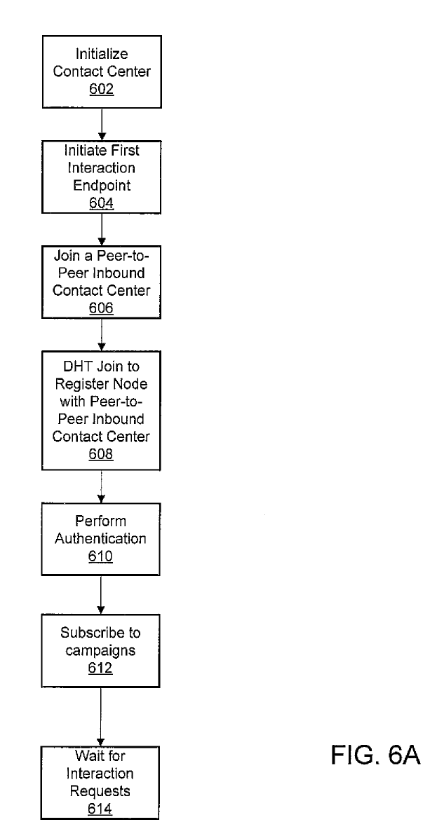

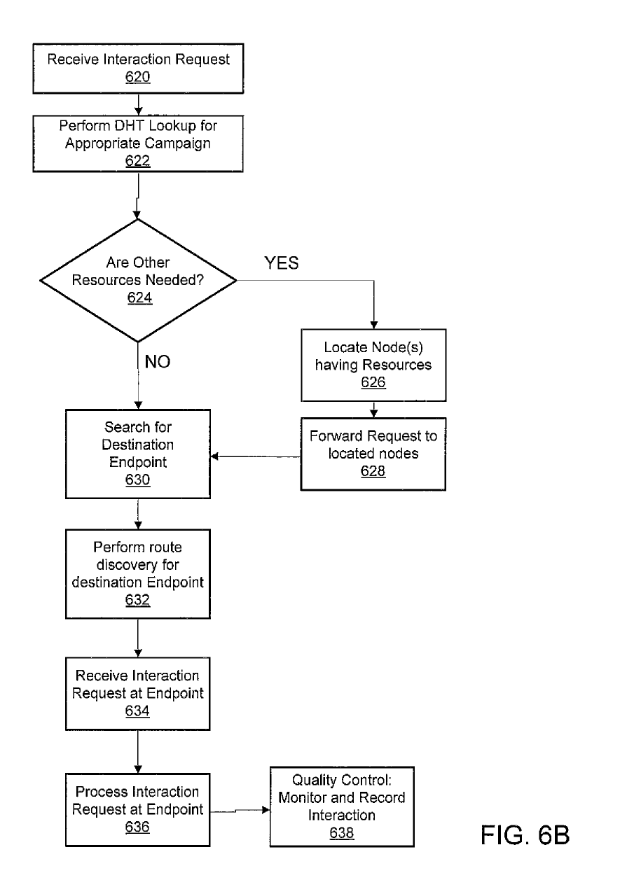

Contact centers consistent with the present invention may be implemented in a variety of deployment models. The contact center system provides inherent flexibility that allows for several types of deployment, such as home based, ad-hoc, enterprise, service provider, regional and global P2P inbound contact centers. Furthermore, the multimedia nature of the peer-to-peer inbound contact center allows for the processing of a variety of interaction requests, such as telephone calls, e-mails, chat requests, etc. FIGS. 6A and 6B are flowcharts illustrating operation of example systems for implementing contact centers. Those of ordinary skill in the art will appreciate that nothing in this description is intended to limit the invention to any particular embodiment or embodiments.

Referring to Step 602 in FIG. 6A, the system for implementing a contact center may include a process for initializing a contact center. A contact center may be initialized by a first interaction endpoint (step 604), which may be any device that is the first node executing the contact center software modules. In the absence of other nodes, the P2P ICC software may only initialize itself, setting up its DHT data and connecting to the local interaction endpoint via the Universal Endpoint Adapter and storing parameters that characterize the capabilities of the node. The node may then wait (i.e. go offline) until an agent logs in via a visual (e.g. GUI) interface of the P2P ICC node. In one example, automated P2P ICC nodes, such as an integrated voice response system (IVR), may go online at this stage.

At step 606, an interaction endpoint may join an existing P2P ICC. The interaction endpoint may first locate some node that is already participating in the P2P ICC. The existing node is referred to as the bootstrap node. An interaction endpoint may use any method to locate the initial bootstrap node, including:
Static nodes: some P2P ICC nodes may have a permanent address that may be pre-configured or obtained via an online registry, such as a Web page. Home based P2P ICC agents may connect to a static node maintained by the P2P ICC service provider in order to start processing interaction requests.
Broadcast mechanisms: new P2P ICC nodes may use a broadcast mechanism to locate the initial bootstrap node, for example using multicast packets.
Cached nodes: when a node attempts to re-join an existing P2P ICC after a disconnection, it may use a local cache of previously contacted P2P ICC nodes to locate its bootstrap node.

Any P2P ICC node may have a resident persistent data store (e.g. a local SQL database or flat text file on a hard disk drive) that may be used during initialization. For example, the data store may be used to set up a set of initial DHT data. Some designated nodes may contain authoritative data that defines administrative aspects of a P2P ICC instance, like privilege levels for specific nodes. Authoritative data may be trusted through a pre-defined rule (e.g. “all data coming from the bootstrap node is to be considered trusted”) or trust may be established using a specific peer to peer algorithm. In one example, a specific trust model may not be required. The existence of trust may be relied upon so that authoritative data may be safely distributed to participating nodes and privilege levels asserted.

At step 608, a new node that has located its initial bootstrap peer node may register with the P2P ICC via a DHT join operation. The new node may hash its IP address to create a node ID that is unique to its local ring, and that it may send to the bootstrap node with a request to join the P2P ICC. Within a DHT hierarchy, the unique ID of a node may be made of a local ring node ID combined with a ring ID. Alternatively, new unique node IDs in a partitioned key space may be allocated to joining nodes by the node from which they bootstrap, who is responsible for maintaining an effectively organized key space. The DHT module may insert the new node in the proper place (e.g. next to the nearest existing node of the new node ID) inside the data structure (e.g. DHT ring) and perform functions such as copying data that the new node may be assigned the task of maintaining.

In example systems for implementing a contact center, a new node registration with a P2P ICC deployment implies joining a DHT and simultaneously going through an administrative authentication process (step 610) to determine if the new node is allowed to register with the P2P ICC. Any P2P ICC software module may implement authentication processes that rely on secure data stored within the DHT or into a well-known authentication server to accept or reject a new node, and assign its privileges based on the information (e.g. profile) submitted by the new node together with its node ID. Authentication may also be performed as part of the DHT join operation or may take place prior to that step using non-DHT mechanisms like Kerberos or proprietary algorithms based on the exchange of data via a secure http connection. The P2P ICC only requires peers to be authenticated, no matter what the authentication method actually is.

At step 612, the node may perform a process of subscribing to campaigns. Each P2P ICC deployment may be characterized by the campaigns it handles. For instance, a given P2P ICC can process incoming phone calls from sales prospects generated by a TV advertisement with a free phone (1-800) number and e-mail enquiries from existing customers, directed to enquiries@mycompany.com. Each interaction endpoint can, depending on its capabilities, subscribe to one or more campaigns supported by its P2P ICC. Subscription may be performed by putting a new key-value pair into the DHT, for example storing as key the campaign name (e.g. “Campaign_MyCompanyEmailEnquiries”) and as value the node ID of the interaction endpoint. A property of most DHT implementations is the ability to support multiple values under a given key.

Each node may also put into the DHT, and periodically refresh, information that may be essential for the correct operation of the P2P ICC program logic, such as for example, the agent status and its status time (for a node with a live agent). For example, a DHT ‘Put’ operation may be issued with keys: “NodeID_AgentStatus” and value “Available”. It may be desired to maintain a permanently up-to-date representation of the status of all the interaction endpoints composing the P2P inbound contact center inside the DHT to enable the P2P ICC program logic to take intelligent interaction request routing decisions, etc. Most of this status information may be recovered from the interaction endpoint via the UEA.

Once initialized, the interaction endpoint may wait for an interaction request as shown at step 614. The initialization process may also involve other steps depending on the nature of the P2P ICC work flow and the program logic implemented in the P2P ICC module.

Referring to FIG. 6B, the interaction endpoint waits for a user-triggered interaction request. When an interaction endpoint receives an interaction request (at step 620), it notifies the P2P ICC module through the UEA. Such an event notification may take place when an incoming call, a call from a user, a click-to-call button press, a chat request, an e-mail or any other supported interaction request is received. The receiving node may then determine how to process the incoming interaction request.

Contact center campaigns may be characterized by a well-publicized contact point, for instance a telephone “number, a Web click-to-call button or banner, or an e-mail address. Traditional routing schemes may deliver all the interaction requests to the interaction endpoint associated with the contact point. For large volume campaigns, there is a risk of overwhelming a P2P ICC device with a load that it may not be able to handle. Solutions to this problem include:
Load balancing: the network may be instructed to deliver-in round-robin fashion-the interaction requests, spreading the load among several endpoints. This may occur in deployments where a single logical contact point (e.g. telephone number) may transparently map to several physical contact channels (e.g. telephone lines).
Server processing: high-capacity P2P ICC devices (i.e. servers) may be installed wherever a high volume contact point may create a processing bottleneck.

The P2P ICC node that has received the interaction request may perform a DHT lookup at step 622 to identify the appropriate campaign. A mapping between contact points and campaigns may be maintained in the DHT. For example, contact point “ContactPoint_{—}1-800-555-1234” may be stored as a key in the DHT, with a value of “Campaign_TVSalesXtraAbs”.

A specific business process or workflow may be associated with a campaign and retrieved using a DHT lookup of the appropriate key. The workflow may specify that an interaction request (a telephone call for example) first be routed to an IVR for obtaining an product number, and then to an agent skilled in handling sales transactions for that said product. At decision block 624, the interaction endpoint checks if the interaction request is routed to a different node. If the interaction request is routed to a different node, the P2P ICC node that received the interaction request may attempt to locate another node with appropriate resources, like IVR channels, using a DHT lookup at step 626. The step of forwarding the interaction request at step 628 from one node to another may be performed at two distinct levels:
P2P ICC overlay level: the DHT is used as a logical storage space to hold all the CTI data collected up to that point. Each interaction request is assigned a unique ID that may serve as DHT key to store the associated CTI data (DHT value). Upon receiving the interaction request, the destination node may be notified by its UEA of the unique ID and may use it to retrieve any CTI data from the DHT.
Interaction endpoint level: the P2P ICC program logic may issue an interaction request forwarding command to the UEA, which may be responsible to map it to the appropriate low level instructions to ensure that the interaction request is forwarded to its destination. For example, for a SIP call the forwarding could be a SIP REFER, for an analog telephone call it could be a hook flash, etc.

The P2P ICC may then search for a destination endpoint to process the interaction request at step 630. At step 632, the P2P ICC may perform route discovery in order to forward interaction requests from one interaction endpoint (node) registered with a DHT ring to another node possibly on a different ring and network. Note that this concerns only interaction requests (e.g. phone calls, e-mails, chat requests, etc.) not the operation of the P2P ICC overlay (i.e. routing within DHTs). In the example shown in FIG. 2, to forward a call from a soft-phone to a PBX extension, the P2P ICC program sends a route discovery request to a dedicated system such as DUNDi (alternatives to DUNDi for routing VoIP calls include ENUM for instance) to locate an appropriate telephony gateway. Once a route has been found and returned to the P2P ICC program, the UEA may be ordered to transfer the call to the destination endpoint using the located gateway. In this example (see FIG. 2), the UEA transfer command is mapped to a SIP REFER sent back to the gateway that may know what TDM trunk to use and telephone number to dial in order to have the designated PBX extension ring. The use of an external (to P2P ICC) gateway locator system permits the construction of multi-network, heterogeneous virtual contact centers while preserving the unifying P2P ICC model regardless of the complexity of the interaction request transport substrate.

Automatic computer programs (so-called “software agents”) may also be supported by the P2P ICC. An example of such an automatic computer program is the IVR that offers self-service capabilities to callers, like checking the status of their order without any human intervention. An IVR node is like any other P2P ICC node, featuring its own P2P ICC program logic, UEA and DHT modules. The UEA interacts with the third party IVR software but does not replace it, i.e. the call is processed by the IVR program not by the P2P ICC program logic. The IVR service script may interact with the UEA to communicate any collected data to the P2P ICC (e.g. the product number keyed in by the caller). For that purpose the UEA offers an open API accessible from various programming languages used in IVR scripts (e.g. Java, Visual Basic, etc.).

Depending on the workflow associated to the campaign, the call may be transferred from the IVR to another node or not. All participating peers in the P2P ICC are presumed equally intelligent and may attempt to execute as many steps of the workflow as materially possible within their resource constraints. Thus a participating software agent (e.g. IVR) node may hand over control to the P2P ICC program logic to continue the workflow execution while storing the updated CTI data into the DHT.

At some stage in the workflow, the interaction request may need to be routed to an endpoint. At step 632, a route discovery may be performed to find a suitable destination endpoint. This routing process can take into account a vast number of parameters, including collected user information stored in CTI data, time and date related constraints, agent specific information (such as his skills, for skills-based routing), geographical data (like the location of the caller, for proximity routing), etc. The goal of the P2P ICC program logic is to make the best possible match between the available parameters and the endpoints that could process the interaction request. One example may be a unified relational database management system (RDBMS) layered on top of the P2P ICC, DHT-based, peer-to-peer network. Such a P2P-enabled RDBMS allows the P2P ICC program to dynamically build a query in SQL or another query language and execute it over the data contained in the DHT. For example, a simple query would be to select the available, non-busy (e.g. not already handling a call, contact center related or not), English speaking, product sales specialist, agent with the longest idle time in campaign “TVSalesXtraAbs”—all these parameters being stored in the DHT and representing the real-time status of each interaction endpoint. The query returns a list of one or more interaction endpoint nodes to which the interaction request can be forwarded for processing, along with the gathered CTI data. The P2P ICC may include software that performs a peer-to-peer, real-time profile matching algorithm for improved skills based routing. Besides traditional SQL queries returning a set of matches, search algorithms with ranking factors can be used to return more relevant results, enhancing the quality of the routing to the best endpoint for a given interaction request. This turns the P2P ICC into a relevance-based search engine for live interactions.

Given the peer to peer nature of the P2P ICC, several nodes can decide at the same time to forward an interaction request to the same endpoint, resulting in a race condition. To resolve this potential problem, the P2P ICC program may attempt to obtain a lock on the endpoint and the interaction request, preventing other nodes from issuing potentially conflicting commands. A handshake procedure is implemented whereby the endpoint must advertise via the DHT its acceptance of the interaction request, while the forwarding node verifies that the endpoint has agreed to process the said interaction request. In the case that no such acceptance is confirmed within a reasonable timeframe, the node tries the forwarding operation up to a pre-defined maximum number of retries. If the operation still fails, the interaction request is queued and may be processed as described further below. Upon completion of the interaction request processing, the endpoint releases the locks, signifying its readiness to accept a new interaction request. Alternative algorithms may be used to prevent or gracefully handle race conditions, such as the token passing mechanism described elsewhere in this invention.

Unforeseen events can modify the status of the endpoint and make it unsuitable for processing the interaction request. For example, the endpoint might suddenly drop out of the network following a power outage. It is the responsibility of the forwarding node to catch such error conditions and find a new suitable endpoint. The forwarding node's UEA may notify the P2P ICC program logic that a given interaction request was not successfully forwarded (e.g. resulting in a SIP error message for VoIP calls).

If no suitable endpoint can be found, the interaction request is queued in a universal queue contained in the DHT. Queuing algorithms such as FIFO, priority queues, overflow queues, etc. may be supported within the P2P ICC program logic. State maintenance of the universal queues stored in the DHT is the shared responsibility of all the participating nodes. Universal queue maintenance may be performed:
On endpoint state changes: when an endpoint becomes available, it may run a query on the universal queue pending interaction requests to see if any of them match its capabilities and status. If a match is encountered, the endpoint can decide to process the interaction request. First it may apply the appropriate locks for avoiding race conditions, and then assign itself as the intended recipient of the interaction request.
While an endpoint is in a stable state: every endpoint's P2P ICC program logic may run a parallel thread of execution where it checks the status of the universal queue. To avoid overloading the CPU of all the endpoints (polling is known to be CPU intensive), only a limited set of endpoints (e.g. 2 or 3 endpoints) may be assigned with the task of monitoring a queue. For example, if a queued interaction is in a priority queue that dictates the automatic increase in priority level after N seconds in the queue, the first endpoint in the designated set of endpoints to detect that the interaction's priority is to be raised locks it and performs the operation. Likewise, if a queued interaction indicates a new recipient, the endpoint where the interaction is currently held may forward it to the specified destination. Should all the nodes from the set designated to monitor a queue become unavailable, the node's DHT post-leave stabilization process may take care of automatically re-assigning the monitoring task to another available node.

Some types of campaigns and workflows may specify that some or all interaction requests be processed by an automated script while held in a queue. These interaction requests may be forwarded to a node featuring the appropriate type of resources and software agent. For example, telephone calls requiring that music on hold be played while in a queue need to be forwarded to an IVR system or an RTP mixer, for example. Hence a queued interaction request may be held or processed at the P2P ICC node best prepared to meet the specified queuing requirements.

At step 634, an interaction request may be received by an appropriate endpoint that may process it. This may be any form of live (e.g. agent/operator) or automatic (e.g. chat expert system) node in the P2P ICC. If the associated workflow specifies any special action upon receiving the interaction request at the endpoint, it may be performed by the P2P ICC program logic. This includes, for example, displaying on the agent's monitor a “screen-pop” with the customer's personal information.

All the endpoints participating in a P2P ICC store real-time and historical statistical data in the DHT, including: endpoint idle time, number of interaction requests handled since going online, time spent in any allowed status (e.g. unavailable, available, lunch, after call work, etc.), time spent in the current status since the last status change, current status, details about the interaction request currently being processed, etc. General contact center statistics are also updated directly in the DHT by the endpoints that access associated data structures, such as universal queues for example. All these statistics, as with the rest of the DHT's data, are stored encrypted.

At registration time, after authentication, some P2P ICC participant nodes may be granted a privilege level that permits them to access some or all of the statistics contained in the DHT hierarchy. They also receive a private decryption key that may allow them to read the statistics. These nodes typically host some sort of supervision, monitoring or reporting software that is not intrinsically part of the P2P ICC program logic, but rather is integrated with it.

P2P ICC nodes with the adequate privilege level may not only read statistical data but also write it to persistent data storage for later reuse. This is another case of integrated application that uses the P2P ICC program logic and API to extend the functionality provided. Offline reporting tools can then read and render the stored statistics to produce historical reports for instance.

Persistent data stores and application platforms such as Web Services in a service-oriented architecture (SOA) may be used by the P2P ICC to perform a variety of operations, such as displaying a screen-pop on an agent's monitor. These external resources, like the database behind a CRM system, may be available to the P2P ICC through a directory of external resources. In an example P2P ICC, if an external resource becomes unavailable, the P2P ICC might not be able to perform its tasks as expected. The P2P ICC can thus be integrated in a complex workflow mashing up various data sources to deliver an entire Web-enabled telephony application across heterogeneous IP telephony or traditional TDM networks. The P2P ICC may itself be packaged as a Web Service embedded in a SOA.”

At step 636, an interaction endpoint may process an interaction request. This may involve a quality control process. At step 638, the interaction may be monitored, for example, by listening to a telephone call between a customer and an agent. This may involve both the P2P ICC and the underlying communication channel handling the interaction data itself, like the telephony audio stream in the example mentioned. The functional decomposition of the P2P ICC and its independence from the interaction data may make it difficult to intervene on the said data, except for routing purposes. Hence for monitoring an interaction, a third party software system may need to first use the P2P ICC program logic via its API to obtain information about the interaction (e.g. the call ID and associated data), and then employ some native methods supported by the underlying communication channel to start monitoring the interaction. Concretely, in the case of a VoIP call, once it has obtained the call ID, the monitoring software may locate either the call endpoint or an intermediate RTP proxy or IP packet sniffer and instruct it to copy the specific RTP stream corresponding to the call ID to an audio device suitable for monitoring the call.

Interaction recording follows the same principle as monitoring an interaction, namely a third party application is integrated with both the P2P ICC and the underlying communication channel to start monitoring and then saving to persistent storage the interaction as it unfolds.

Once a suitable overflow endpoint is located inside a foreign DHT ring, the interaction request can be forwarded using the method described earlier (e.g. using a route discovery system like DUNDi). The CTI data needs to be accessible from the destination endpoint's P2P ICC program logic. Depending on the established trust between the rings, the endpoint can either do a direct lookup of the data or the CTI data can be copied into the gateway uniting the foreign ring with the DHT hierarchy.

Together with a trust relationship, all the participants into a given P2P ICC hierarchy of DHT rings need to be bound by a business agreement. This means that business information must be stored where appropriate to specify important criterions for collaborative interaction requests processing, such as the price to handle an interaction request, spending limits, etc. In an overflow situation, an originating P2P ICC may decide to keep an interaction request queued instead of immediately passing it over to a foreign DHT ring available agent whose price is considered prohibitive. Such business rules can be implemented in the business process or workflow associated with a specific campaign. The P2P ICC program logic can then strictly enforce these rules while handling interaction requests.

The P2P ICC may implement contact center marketplaces. In such a scenario, the marketplace operator would own the top-level DHT ring of the hierarchy. The operator could then open a marketplace portal (e.g. a Web site), or any similar facility, where it would bring together businesses needing their campaigns to be run (the “publishers”) and contact centers or even private individuals looking for new campaigns to handle (the “subscribers”). Campaign publishers may set up their campaigns below the top level of the DHT ring hierarchy, and invite campaign subscribers to get connected, thus forming an ad-hoc virtual contact center created for the purpose of the campaign. The contact center marketplace may feature the necessary tools for rating participants, auctioning campaigns and billing transactions.

The fully dynamic nature of the P2P ICC permits nodes to leave at any time (as well as joining at any time). A node leaving gracefully the DHT ring needs to copy all of its stored information to appropriate participating nodes in the DHT. An appropriate node might be the leaving node's predecessor, depending on the DHT substrate used. Thus no data is ever lost in such a scenario. Data is also replicated amongst many nodes to improve fault tolerance. If the departure of a node from the P2P ICC affects the processing of an interaction request, for example if a telephone call is held at that node, it is the node's responsibility to update the DHT data as needed. For instance, if the call is lost, the node needs to clean up the CTI data about the call from the DHT as well as other possible associated information (e.g. workflow data).

DHTs are fault tolerant constructs where data is replicated among more than one participating node. Hence the failure of a single node would only affect the interaction requests currently processed at that node, but none of the P2P ICC operational data. As a safeguard mechanism, failure of a node may be picked up by other neighboring nodes and when running their DHT stabilization routine (an automatic, periodic, operation in many DHT implementations) may clean up the data that used to pertain to the failed node.

### A. Alternative Embodiments

P2P ICC program logic: as true with any peer to peer overlay networks, a P2P ICC may be implemented using several valid architectural models, for example: intelligent super nodes, where all the program logic would be found and executed, leaving interaction endpoints as dumb nodes; lightweight nodes with limited processing capabilities or memory storage that would defer via some communication protocol (e.g. http) most decisions to proxy nodes capable of running the full DHT and P2P ICC program logic; interaction endpoints as virtual machines, dynamically downloading the program logic from bootstrap nodes if not found in the local cache and executing it on the node itself. These two architectural alternatives, and many more not presented here, still rely on the fundamental concept of a peer to peer deployment.

Distributed Hash Tables (DHTs): DHTs may not be the only foundation upon which to implement the P2P ICC. Any substrate capable of delivering equal or superior peer-to-peer characteristics than DHTs could be used in the P2P ICC.

Hierarchical Distributed Hash Tables (HDHTs): the HDHT architecture of the P2P ICC follows a vertical approach where every layer (also called leaf) in the hierarchical tree of DHT rings is a self-contained DHT. Alternative approaches exist, for example a horizontal and uniform leaf-based schema or a series of independent DHT rings with partitioned key spaces, each including a central node acting as an intelligent communication bridge between these DHT rings. Any technological solution allowing the creation of a structured network of P2P ICC instances with characteristics of high performance, robustness, scalability, privacy and security is a candidate to replace HDHTs. The nature of HDHTs, whether vertical or horizontal, makes them ideal for that purpose.

Polling Model: in the preferred embodiment of the P2P ICC, the node having received a notification via its UEA that an interaction request has been received, may actively query the DHT to find the most appropriate endpoint to process the interaction request and forward it to that endpoint (Push Model). Hence, decisions are made on the behalf of a given endpoint by another node. For example node A decides that node B is the most appropriate endpoint to receive a forwarded interaction request. This does not need to be so. Since the DHT hierarchy contains at any time the true state of a P2P ICC, individual nodes could take decide to process interaction requests by polling (i.e. “reading the content of”) the DHT logical storage space. In that polling model, an endpoint would finish processing an interaction and lookup in the DHT if any interaction request is pending that matches its capabilities and status. If such an interaction request is found, the endpoint would request the node currently holding the interaction request to forward it to itself. This could be an alternative embodiment of the present invention. A business agreement may exist between contact centers prior to being able to automatically “grab” interaction requests from a business partner.

IV. Systems and Methods for Initiating Connections from a Visual User Interface

In some examples of P2P ICCs consistent with the present invention, systems and methods may be implemented for initiating connections to the contact center from a user interface on a client device. Example P2P ICCs such as those described above have data network connectivity to provide for communication over data networks such as the Internet. Potential clients or users of the P2P ICCs may connect with agents on a P2P ICC over the Internet using a client device such as a personal computer or softphone or any other type of device described above. In one example of the present invention, a potential client or user may establish a connection to an agent of the P2P ICC by using a mechanism on the user interface of the client's device. For example, a web page may have a button programmed to initiate a connection as described in more detail below when the user clicks on the button.

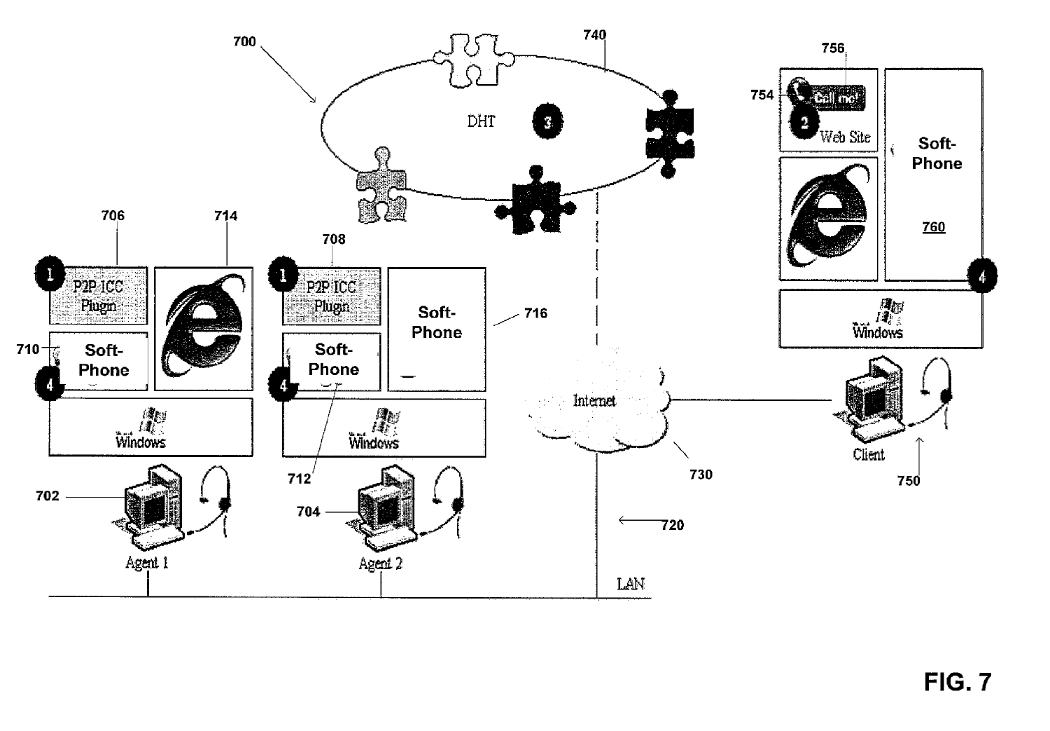

FIGS. 7-14 illustrate an example of how such a system may advantageously provide an enterprise using a P2P ICC with quick and easy access to customers, potential customers, buyers or potential buyers of the enterprise's product(s), or anyone seeking information that may influence a decision to do business with the enterprise. Such a system benefits from the ease of implementation, scalability, and low-cost deployment of a P2P ICC consistent with the present invention.

The flexibility of a P2P ICC allows an enterprise to use one in a variety of ways. For example, an enterprise may implement, or sponsor, its own P2P ICC system. Alternatively, the enterprise may contract with a third-party contact center, which would implement the contact center as a P2P ICC. In another alternative, a Web-service provider (e.g. Google, Yahoo!, etc.) may offer a P2P ICC as a feature, or a service add-on to allow its subscriber enterprises resources for promoting their products, services, etc. FIG. 7 is a network diagram showing an example P2P ICC 700 implemented by a hypothetical enterprise that employs two salespersons (Agent 1 and Agent 2). In the examples described below, the hypothetical enterprise Agents 1 and 2 use first and second PCs 702, 704, each PC 702, 704 having, without limitation:

a P2P ICC plug-in 706, 708;

a softphone client 710, 712 (e.g. Skype VOIP client);

an Internet browser 714, 716;

and an interface to a local area network (LAN) 720.

The LAN 720 provides the Agents' PCs 702, 704 with access to the Internet 730 and access to a DHT 740 having an overlay structure configured to provide peer-to-peer connectivity between devices having the DHT system embedded in the P2P ICC plug-in 706, 708. Alternatively, the DHT 740 may be implemented using the OpenDHT public P2P service, which is a publicly accessible distributed hash table (DHT) service. In contrast to the usual DHT model, clients of OpenDHT do not need to run a DHT node in order to use the service. Instead, they can issue put and get operations to any DHT node, which processes the operations on their behalf. No credentials or accounts are required to use the service, and the available storage is fairly shared across all active clients; although there may be a sacrifice in terms of performance.

The client may also access the Internet 730 using a client PC 750, which may include, without limitation:

a client Internet browser 752;

a user interface 754;

and a client softphone 760 (e.g. Skype softphone).

In an example scenario, the client may navigate the web and browse the enterprise's web-site using the client Internet browser 752. The enterprise's web-site may include a connector 756 on its web page. This connector 756 may be any button, link, URL or other mechanism for sending a request for a connection over the Internet. In one example implementation, the connector 756 is implemented using Flash (or AJAX) and may feature active code. The connector 756 may be provided as part of a campaign in accordance with the enterprise's strategy in implementing the P2P ICC 700. The campaign is assigned a group of agents to handle calls at the P2P ICC 700.

During operation, the Agent PCs 702, 704 use P2P ICC plug-ins 706, 708 to operate in the P2P ICC 700. The P2P ICC plug-ins 706, 708 are examples of P2P ICC software packages described above with reference to FIGS. 1-6 and may be downloaded by the salespersons on to the Agent PCs 702, 704 from a suitable web-site. When installed, the P2P ICC plug-in 706, 708 may register (either automatically, or through user intervention) with a softphone API, which in the example shown in FIGS. 7-14 is a Skype softphone client 710, 712. The installation and registration process may include storing information about the agents in the DHT 740. The agents may be assigned a group name, e.g. Group 1. The group name, the agents' identifying information, and additional information may be stored in the DHT 740.

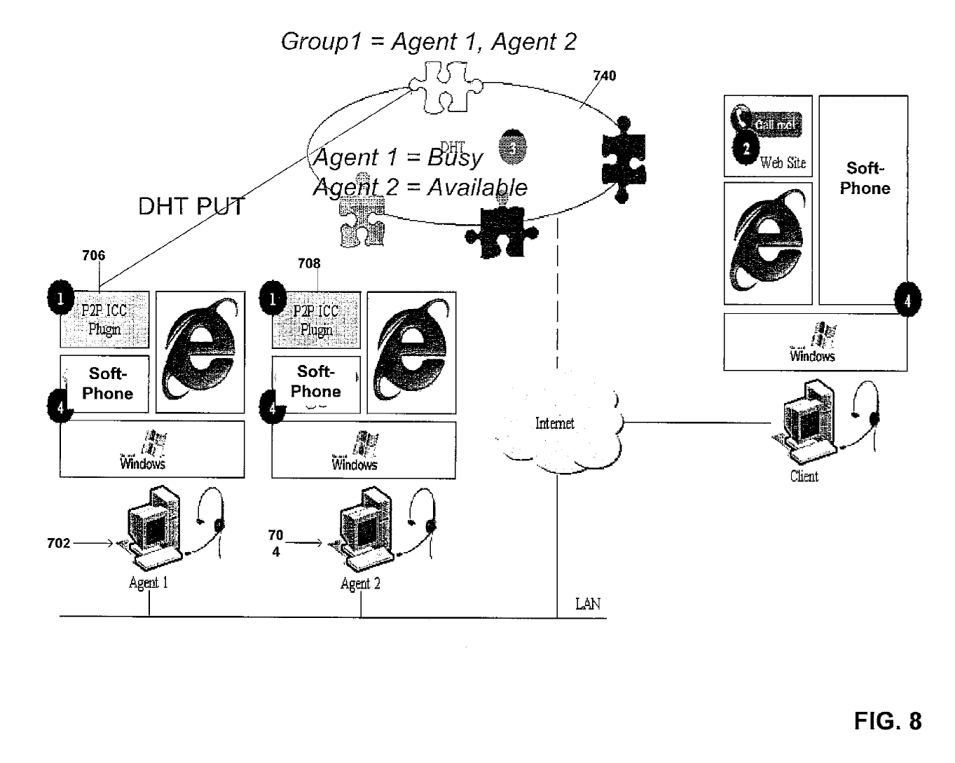

FIG. 8 shows a store operation (DHT PUT) being used to store the group name and its members (GROUP 1=AGENT 1, AGENT 2), and a presence status code, which in this example indicates whether a corresponding agent is available or busy (AGENT 1=BUSY, AGENT 2=AVAILABLE). The presence status code may have other values, such as, for example, OUT TO LUNCH, TRAINING, etc. The presence status code may be set using presence management features that may be on the softphone 710, 712, by features added to the P2P ICC plug-in 706, 708, or any other suitable implementation. The group identifier and the presence status code may be stored along with a DHT data structure for each agent. The DHT may store other information that may change during a call, such as CTI data sent This data may include any information the connector can retrieve from the user's browser or Internet device, from the Web site the user is logged on, or from any other data source accessible by the connector when it is triggered by the user (e.g. via a “click”).

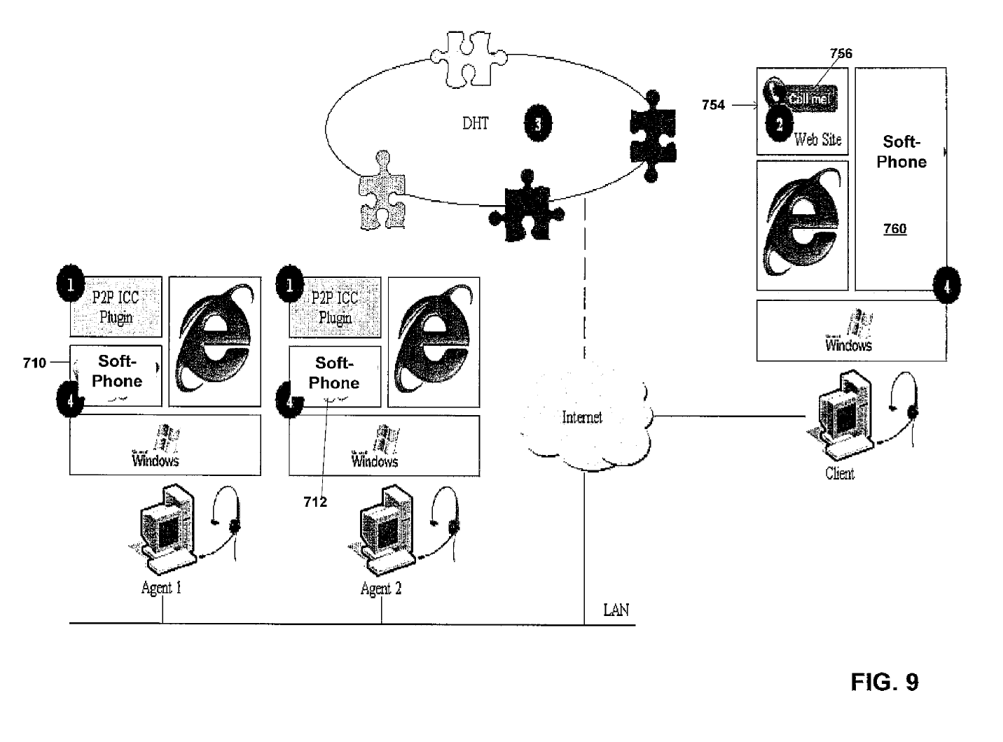

As shown in FIG. 9, a client may browse the enterprise web-site and with the enterprise's web page on the user interface of the client PC 750, the client may select (or “click”) the connector 756 to initiate a connection to the enterprise, which uses the P2P ICC as its interface to its customers. The connection may take any form of communication, such as (without limitation) a telephone call or a chat request. In the example illustrated in FIGS. 7-14, the connection is an Internet telephony call using the client's softphone 760, and the agent softphone 710 or 712. The connector 756 may be programmed to determine its campaign in order to connect directly to its group, i.e. Group 1.

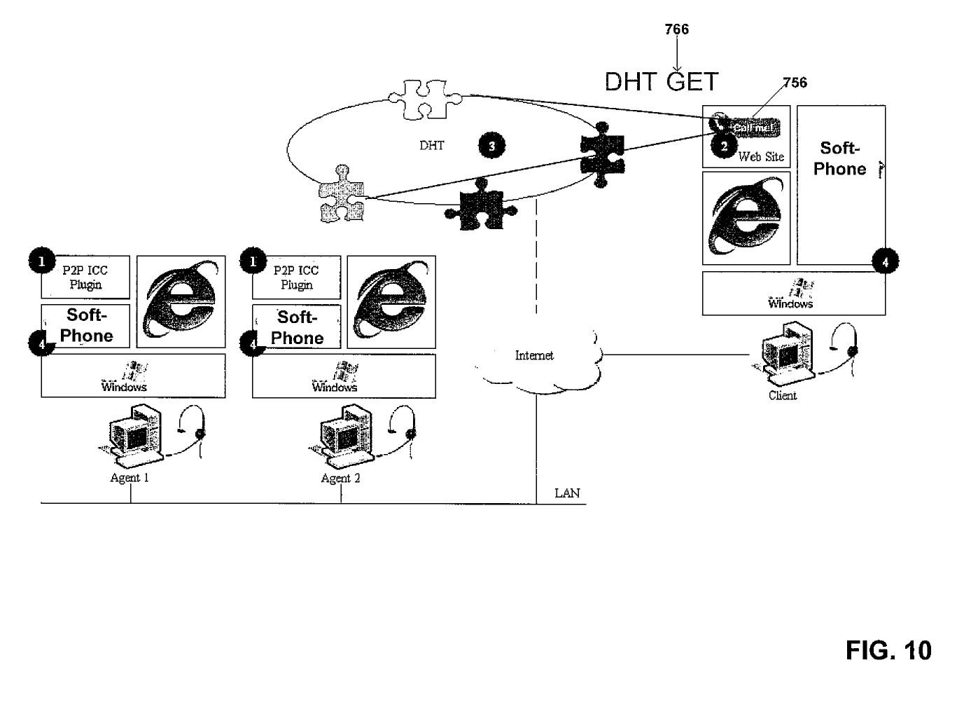

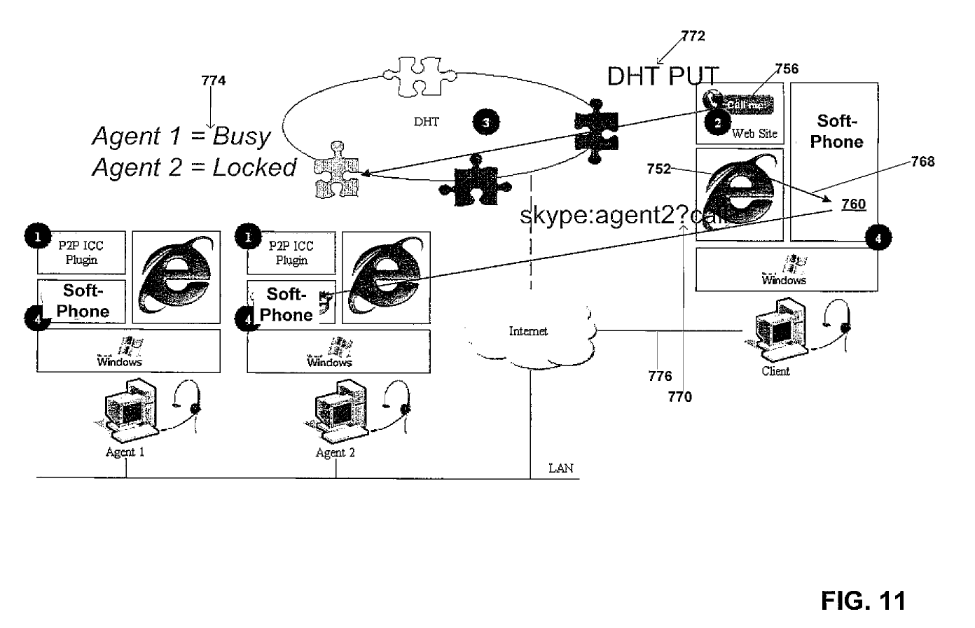

As shown in FIG. 10, the connector 756 accesses the OpenDHT public service 740 and retrieves information 766 regarding its campaign and other information that may be required for processing the connection request and for routing it, i.e. Group 1. In examples of a P2P ICC, an automatic call distributor (“ACD”) may be implemented to distribute calls to the appropriate agent. Table I is an example of pseudo-code for a program that an ACD may use to determine the destination of the connection. Once the connector 756 determines the destination of the connection, it may begin to initiate the call by first building an address. As shown in FIG. 11, an address 770 may take the form of an URL (in this case, a Skype URL). The connector 756 may send the address 770 to the client Internet browser 752. The browser 752 may then instantiate the address 770 using the client softphone 760 to make a VoIP call 776. The client softphone 760 makes the call 776 to the available agent (Agent 2) to begin the conversation that may net the client the desired information. When the call 776 is successfully initiated, the connector 756 may send a lock status, or another status variable (e.g. “IN CALL”, “BUSY”) to the Agent presence status 774 (NOTE: The pseudo-code shown in Table I does not implement a, using instead an alternative synchronized data access method known as token passing). This notifies other clients that Agent 2 is not available. An alternative session initiation method involves the agent calling the user instead of the opposite. In this “call-back” example, the user first inputs the address of the device or software where he wishes to be called, for example, his cellular phone number. This information is stored in the DHT and used by the P2P ICC to place the call. The agent's interaction endpoint, such as a soft-phone, may be used to connect to the user, or an intermediate platform may establish a connection to the agent and thereafter another connection to the user, bridging both media streams to enable a conversation between the parties.

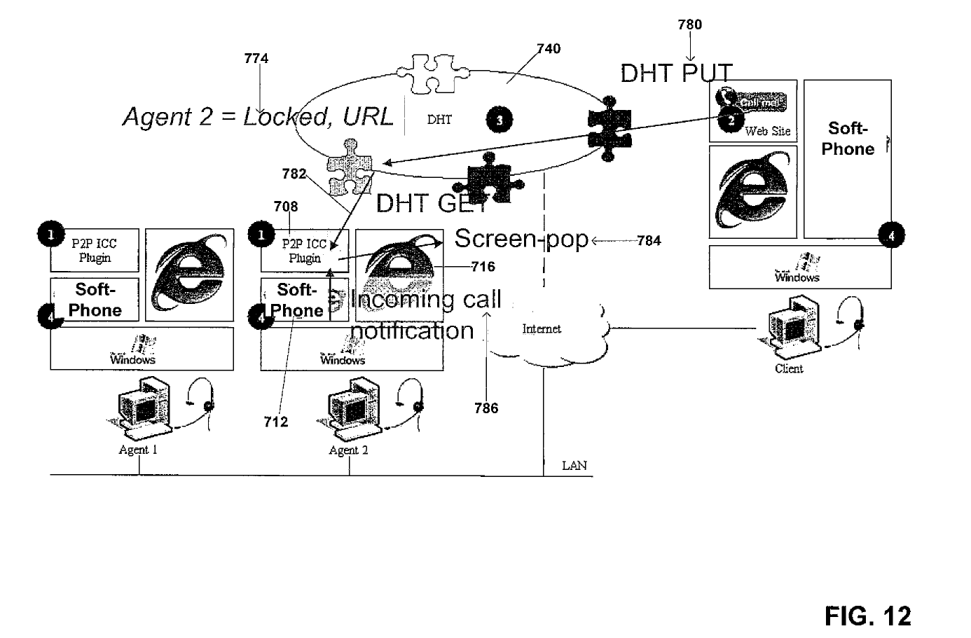

As shown in FIG. 12, the connector 756 may also send information 780 that may include an identifier (such as an URL) of the web page the client was browsing to the OpenDHT public service 740 at the DHT data structure (described above with reference to FIG. 8). When the agent's PC 704 receives the incoming call, the softphone client 712 sends an incoming call notification 786 to the P2P ICC plug-in 708. The P2P ICC plug-in 708 may then send a request 782 for the identity of the web page that the client was viewing from the DHT data structure. The P2P ICC plug-in 708 may then send a CTI screen pop to access the web page to the agent's Internet browser 716. The call then proceeds between the user and the agent both viewing the same web page.

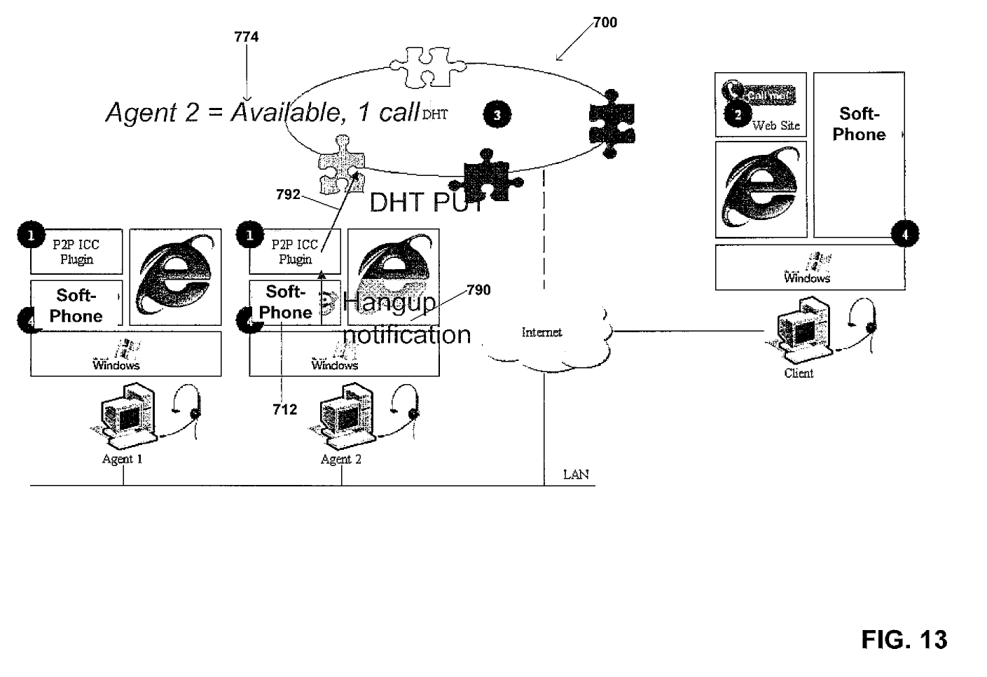

FIG. 13 depicts a procedure for terminating the call in the P2P ICC 700. When the agent or user hangs up, the softphone client 712 sends a hangup notification 790 to the P2P ICC plug-in 708. The P2P ICC plug-in 708 sends a status update 792 to the OpenDHT public service 740 to indicate Agent 2's presence status 774 as available. In addition, the agent's DHT variable data structure may be updated to increment the number of the agent's calls that day (or week, or month, etc.). Other statistics may also be added or updated.

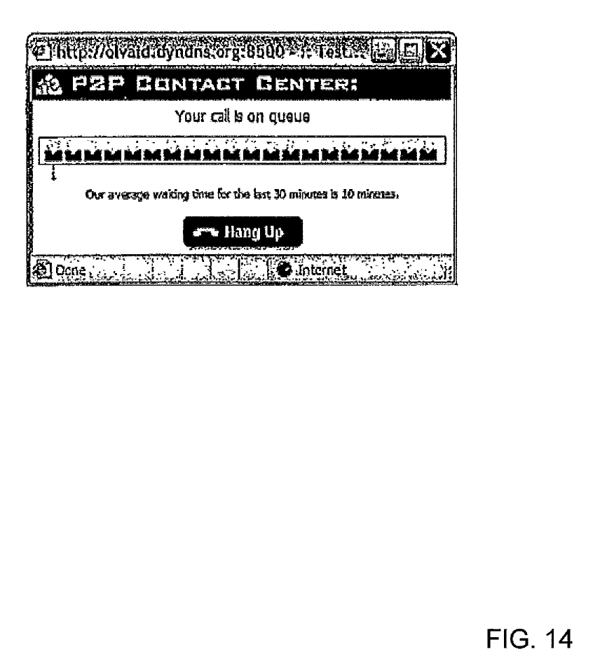

FIGS. 7-13 depict operation when agents are available. If, when the user selects the connector 756, no agent is available, the call is queued and the user is notified with a pop-up window as shown in FIG. 14. The pop-up window includes information such as an estimated wait time related to its calculation based on queue data stored in the DHT. The estimate may be refreshed periodically.

TABLE 1

| | |
|---|---|
| i. | BUTTON> has been clicked, thus put a new call request into the campaign |
| | queue. Put Campaign.Queue.(value_a). Value_a may be made of the ButtonID |
| | and the date and time of the request. Other buttons proceed identically, |
| | appending more call requests to the campaign queue. Put |
| | Campaign.Queue.(value_b). |
| ii. | AGENT> becomes available, thus eligible for the token. The agent may publish |
| | that it wants the token in order to take its next call. Put |
| | Campaign.Queue.WantToken.(AgentID+date/time). This gets appended to the |
| | list of agents wanting to receive the token. The agent may then poll the |
| | Campaign.Queue.Token DHT variable until its AgentID appears, meaning the |
| | token has been received. If no change has been detected after TokenTimeout |
| | polling time (e.g. 30 seconds), the longest waiting agent (according to the |
| | content of Campaign.Queue.WantToken) will grab the token. Remove |
| | Campaign.Queue.Token, Put Campaign.Queue.Token.(AgentID+date/time), |
| | Remove Campaign.Queue.WantToken. From now on it is assumed the agent |
| | has the token and can legally perform operations in the campaign queue. |
| iii. | AGENT> obtain the list of calls queued in the campaign it belongs to (how the |
| | agent knows what campaign it belongs to is not reviewed here (this information |
| | may be passed to the agent P2P ICC program logic when joining the DHT during |
| | bootstrap); an agent belonging to multiple campaigns must take the longest |
| | waiting call from all the campaigns it is signed into). Get |
| | Campaign.Queue.(value_a, value_b, ...). |
| iv. | AGENT> will pop the longest waiting call from the queue (FIFO behaviour). |
| | Remove Campaign.Queue. |
| v. | AGENT> will notify the button who's made that call that it should now place the |
| | call to the agent. Put ButtonID.CallMe.(AgentID+SkypeID+date/time). Although |
| | the caller might no longer want to make the call, the agent should wait for the |
| | call and immediately relinquish the token to the next agent wanting it in order to |
| | preserve the overall response time of the system. If the token comes back to an |
| | agent still waiting for a call after more than TimeoutCallMe seconds, the next |
| | longest waiting call in the queue should be popped and processed. |
| vi. | AGENT> should explicitly pass the token to the next agent who's been longest |
| | in line. Put Campaign.Queue.Token.(value_b). |
| vii. | BUTTON> keeps polling until an agent accepts its call. Get |
| | ButtonID.CallMe.(AgentID+SkypeID+date/time). The remaining wait time in the |
| | queue is estimated by getting the content of Campaign.Queue and can be |
| | displayed in the button. The caller may decide to cancel (hangup) the call. The |
| | agent waiting for the call should be notified of that fact (e.g. by clearing up the |
| | ButtonID.CallMe variable). |
| viii. | BUTTON> should send via CTI to the agent the data associated with the call. Put |
| | AgentID.CTI.(WebPageURL+ any_other_data_collected_on_the_user_side). |
| ix. | BUTTON> should place the call using the Skype soft-phone of the caller's PC. |

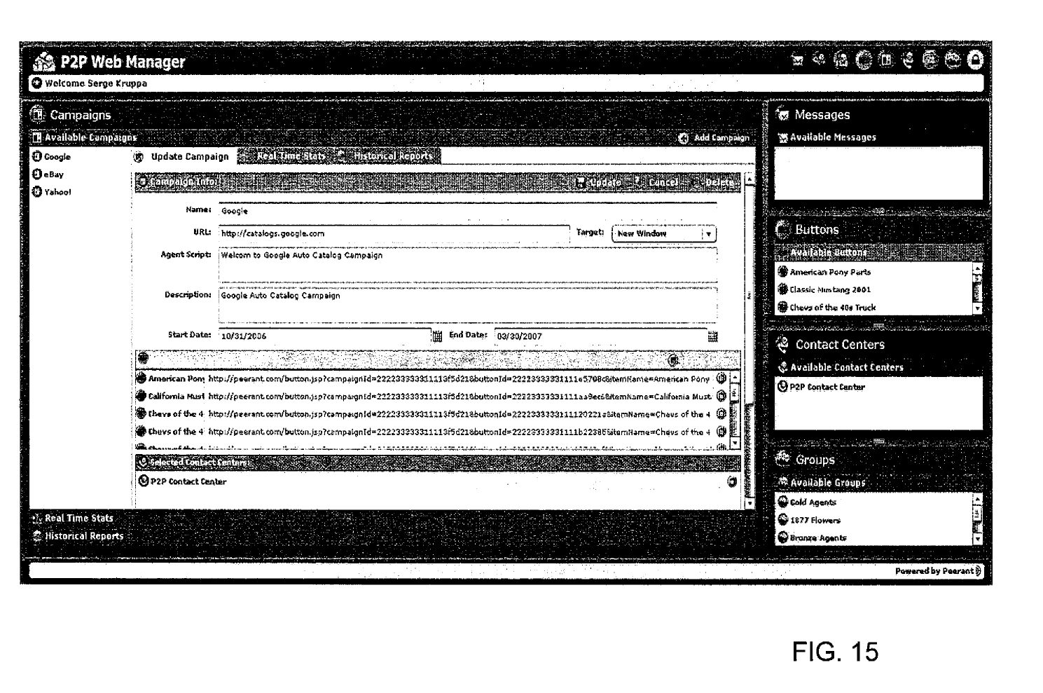

FIG. 15 is an example of user interface for a Web Manager that may be used in a P2P ICC consistent with the present invention. The campaign manager is an administrative tool that can be Web based, and that connects to the DHTs (any P2P ICC instance) in order to provide administrative functions such as: adding campaigns, viewing campaign statistics, adding agents or groups, associating groups with campaigns, etc. The campaign manager is effectively a user interface for the visualization and modification of the data and status of the DHTs for the various P2P ICCs. This is the natural complement to the P2P ICC program logic executed in the plugin and the buttons implemented as lightweight nodes communicating with a full-featured DHT and P2P ICC proxy.

Examples of contact center systems that address the shortcomings of contact centers in the prior art are described above. One of ordinary skill in the art will appreciate that many advantages and features are available through embodiments of the present invention. For example, embodiments provide virtually unlimited scalability and vastly improved reliability thanks to the use of innovative peer-to-peer technologies. The server-less nature of P2P allows the organic growth of distributed, interconnected, self-organizing networks of edge devices of equal or complementary capabilities. Such networks do not require central servers to operate and the failure of a single node will not affect more than a few other nodes, not the whole network.

Depending on the type of edge device to be incorporated into a contact center setup, the installation time can be as low as minutes or even no-time at all. Two nodes of an ad hoc network that was just created will be able to receive and process inbound interaction requests with minimum delays, assuming that a media path exists between the originating points and the endpoints of the interactions.

The foregoing description of an implementation has been presented for purposes of illustration and description. It is not exhaustive and does not limit the claimed inventions to the precise form disclosed. Modifications and variations are possible in light of the above description or may be acquired from practicing the invention. For example, the described implementation includes software but the invention may be implemented as a combination of hardware and software or in hardware alone. Note also that the implementation may vary between systems. The claims and their equivalents define the scope of the invention.

I claim:

1. A system for implementing a contact center comprising:
a data network;
a plurality of devices, each having a central processing unit, memory resources and a data network interface to the data network;
an interaction endpoint operating in each device to communicate in a peer-to-peer communications connection over the data network;
a peer-to-peer inbound contact center (“P2P ICC”) software component operable to execute in each device, the P2P ICC software component having:
a automatic call distributor to handle inbound interaction requests from a requesting device used by a user to initiate the interaction request; and
a distributed network interface to a distributed network of peer-to-peer connections, the distributed network interface being operable to monitor the state of the peer-to-peer connections and to initiate peer-to-peer connections in the distributed network;
an endpoint adapter operable to interface between the P2P software component and the interaction endpoint.

2. The system of claim 1 where the distributed network interface includes a distributed hash table having a peer-to-peer overlay network structure.

3. The system of claim 1 where the interaction endpoint is a function selected from the group consisting of: an email function, a telephony function, a chat-room interface function, a browser and link to a web-site on the World-Wide Web, a Small Message System (SMS) function, and an interaction request function.

4. The system of claim 1 further comprising hardware and software components operable to perform telephony functions.

5. The system of claim 4 where the hardware and software components perform VoIP telephony functions.

6. The system of claim 4 where the hardware and software components comprise a soft-phone.

7. The system of claim 4 where the hardware and software components include an interface to a computer telephony integration (CTI) enabled private branch exchange (PBX) system.

8. The system of claim 1 further comprising at least one other device having the contact center function.

9. A device node comprising:
a central processing unit, memory resources and a data network interface to a data network;
an interaction endpoint operable to communicate in a peer-to-peer communications connection over the data network;
a peer-to-peer inbound contact center (“P2P ICC”) software component operable to execute in each device, the P2P ICC software component having:
a automatic call distributor to handle inbound interaction requests from a requesting device used by a user to initiate the interaction request; and
a distributed network interface to a distributed network of peer-to-peer connections, the distributed network interface being operable to monitor the state of the peer-to-peer connections and to initiate peer-to-peer connections in the distributed network;
an endpoint adapter operable to interface between the P2P software component and the interaction endpoint.

10. The networked device node of claim 9 where the distributed network interface includes a distributed hash table having a peer-to-peer overlay network structure.

11. The networked device node of claim 9 where the interaction endpoint is a function selected from the group consisting of: an email function, a telephony function, a chat-room interface function, a browser and link to a web-site on the World-Wide Web, a Small Message System (SMS) function, and an interaction request function.

12. The networked device node of claim 9 further comprising hardware and software components operable to perform telephony functions.

13. The networked device node of claim 12 where the hardware and software components perform VoIP telephony functions.

14. The networked device node of claim 12 where the hardware and software components comprise a soft-phone.

15. The networked device node of claim 12 where the hardware and software components include an interface to a computer telephony integration (CTI) enabled private branch exchange (PBX) system.

16. A method for implementing a contact center comprising:
receiving an interaction request at an interaction endpoint via a data network connection from a requesting device;
searching for a destination endpoint for handling the interaction request in a distributed data structure corresponding to a distributed network of peer-to-peer connections;
determining a route to the destination endpoint; and
establishing a peer-to-peer connection to the destination endpoint.

17. The method of claim 16 where the step of searching for the destination endpoint further comprises the step of performing a LOOKUP function in a distributed hash table (DHT).

18. The method of claim 6 further comprising:
creating a transfer connection between the requesting device and the destination endpoint.

19. A peer-to-peer inbound contact center (“P2P ICC”) software component operable to execute in a device having a central processing unit (“CPU”) and memory, the P2P ICC software component comprising:
program logic configured to receive an interaction request at an interaction endpoint via a data network connection from a requesting device;
program logic configured to search for a destination endpoint for handling the interaction request in a distributed data structure corresponding to a distributed network of peer-to-peer connections;
program logic configured to determine a route to the destination endpoint; and
program logic configured to establishing a peer-to-peer connection to the destination endpoint.

20. The P2P ICC software component of claim 19 further comprising:
program logic configured to interface to a distributed hash table (DHT); where the program logic configured to search for the destination endpoint further comprises the program logic configured to perform a LOOKUP function in a distributed hash table (DHT).

21. The P2P ICC software component of claim 19 further comprising:
program logic configured to create a transfer connection between the requesting device and the destination endpoint.
